(19) United States
(12) Patent Application Publication
(10) Pub. No.: US 2025/0223019 A1
(43) Pub. Date: Jul. 10, 2025

(54) DRIVING SUPPORT METHOD AND DRIVING SUPPORT SYSTEM

(71) Applicant: KAWASAKI MOTORS, LTD., Akashi-shi (JP)

(72) Inventors: Tatsumasa MURAI, Akashi-shi (JP); Hirotoshi SHIMURA, Akashi-shi (JP)

(21) Appl. No.: 18/409,471

(22) Filed: Jan. 10, 2024

(51) Int. Cl. B63C 9/00; G08B 21/08

(52) U.S. Cl. CPC B63C 9/0005; G08B 21/088

(57) ABSTRACT

A driving support method according to one aspect is a driving support method of supporting driving of a watercraft. The driving support method includes: by processing circuitry, receiving a warning request including positional information of a warning point; determining whether or not the watercraft is within a warning region including the warning point; and when the processing circuitry determines that the watercraft is within the warning region, outputting warning information.

### BACKGROUND OF THE INVENTION

### Field of the Invention

The present disclosure relates to a driving support method and a driving support system.

### Description of the Related Art

Personal watercrafts which travel on water and all-terrain vehicles, such as utility vehicles, are higher in the degrees of freedom of traveling directions and routes than vehicles which travel on public roads.

### SUMMARY OF THE INVENTION

A driving support method according to one aspect of the present disclosure is a driving support method of supporting driving of a watercraft. The driving support method includes: by processing circuitry, receiving a warning request including positional information of a warning point; determining whether or not the watercraft is within a warning region including the warning point; and when the processing circuitry determines that the watercraft is within the warning region, outputting warning information.

A driving support system according to one aspect of the present disclosure is a driving support system that supports driving of a moving machine. The driving support system includes: an antenna that wirelessly receives a warning request including positional information of a warning point; a position detection sensor that detects a position of the moving machine; an informer; and processing circuitry configured to determine whether or not the position of the moving machine which has been detected by the position detection sensor is within a warning region including the warning point indicated by the warning request received by the antenna, and when the processing circuitry determines that the position of the moving machine is within the warning region, output warning information by using the informer.

A driving support system according to another aspect of the present disclosure is a driving support system that supports driving of a watercraft. The driving support system includes: an antenna which is located at a warned watercraft and wirelessly receives falling information indicating that a user has fallen into water from a warning watercraft different from the warned watercraft that is the watercraft, the warning watercraft being another watercraft, the falling information including information regarding a falling position or a position of the user who has fallen into water; a display located at the warned watercraft; and processing circuitry configured to display on the display a warning region surrounding the position indicated by the falling information.

### BRIEF DESCRIPTION OF THE DRAWINGS

FIG. 1 is a diagram for explaining the overview of a driving support system.

FIG. 2 is a side view of a personal watercraft.

FIG. 3 is a block diagram showing the driving support system.

FIG. 4 is a flowchart showing one example of warning request processing that is part of driving support processing.

FIG. 5 is a flowchart showing one example of warning output processing that is part of the driving support processing.

FIG. 6 is a diagram showing one example of a screen image of a mobile terminal.

FIG. 7 is a diagram showing another example of the screen image of the mobile terminal.

FIG. 8 is a diagram showing yet another example of the screen image of the mobile terminal.

FIG. 9 is a block diagram showing a modified example of the driving support system.

FIG. 10 is a flowchart showing a modified example of the warning request processing.

FIG. 11 is a flowchart showing Modified Example 1 of the warning output processing.

FIG. 12 is a flowchart showing Modified Example 2 of the warning output processing.

### DETAILED DESCRIPTION

Hereinafter, an embodiment will be described with reference to the drawings.

### Embodiment

### Overview of Driving Support System

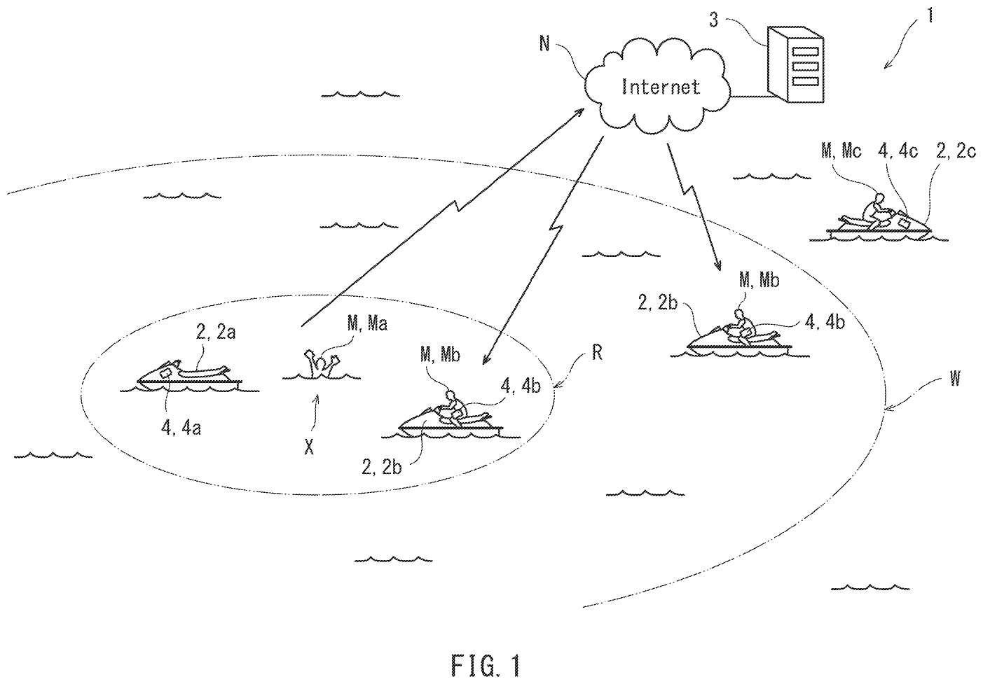

FIG. 1 is a diagram for explaining the overview of a driving support system 1 according to an embodiment. In the following description, a personal watercraft may be abbreviated as a PWC. The driving support system 1 supports the driving of drivers of PWCs 2.

As shown in FIG. 1, the PWCs 2 may exist on a water surface of a water area (for example, the sea or a lake). Each PWC 2 is utilized by one or more users M. The users M of the PWC 2 include a driver of the PWC 2. The users M of the PWC 2 may include an occupant who is on the PWC 2 together with the driver.

In the present embodiment, while the PWC 2 is traveling, a mobile terminal 4 moves together with the PWC 2. For example, the mobile terminal 4 may be carried by the user M who utilizes the PWC 2 or may be located at the PWC 2. For example, the mobile terminal 4 may be carried by the user M so as to be attached to a life jacket worn by the user M, put in a pocket of the life jacket, or attached to the user M. For example, the mobile terminal 4 may be located at the PWC 2 so as to be accommodated in an accommodating box included in the PWC 2 or held by a holder fixed to a water vehicle body of the PWC 2. The mobile terminals 4 can communicate with a server 3 through a communication network N. The mobile terminals 4 are, for example, smartphones.

As shown in FIG. 1, in some cases, the user M falls into water from the PWC 2 while the PWC 2 is traveling. In FIG. 1, the user M who has fallen into water is shown by a reference sign Ma, and the PWC 2 of the user M who has fallen into water is shown by a reference sign 2a. Since the PWC 2 travels on water, the PWC 2 is higher in the degrees of freedom of traveling directions and routes than vehicles which travel on public roads. Therefore, a surrounding range that the driver of the PWC 2 should confirm is large, and it is difficult for the driver to recognize whether or not the drivers of the other PWCs 2 have fallen into water.

According to the driving support system 1 of the present embodiment, when the user of one PWC 2 has fallen into water, information regarding the falling of the user into water is informed through the server 3 to the users M who are within a predetermined informing region W including a position (hereinafter referred to as a falling position) X where the user has fallen into water. In FIG. 1, the PWC 2 within the informing region W is shown by a reference sign 2b, and the user M of the PWC 2b is shown by a reference sign Mb. Moreover, in FIG. 1, the PWC 2 outside the informing region W is shown by a reference sign 2c, and the user M of the PWC 2c is shown by a reference sign Mc.

The informing region W includes a predetermined warning region R located in the vicinity of the falling position X. The driving support system 1 supports the driving of the PWC 2 by warning the user Mb within the warning region R that the user Mb is located in the vicinity of the falling position X. Details of the output of warning information by the driving support system 1 will be described later.

### Configuration of PWC

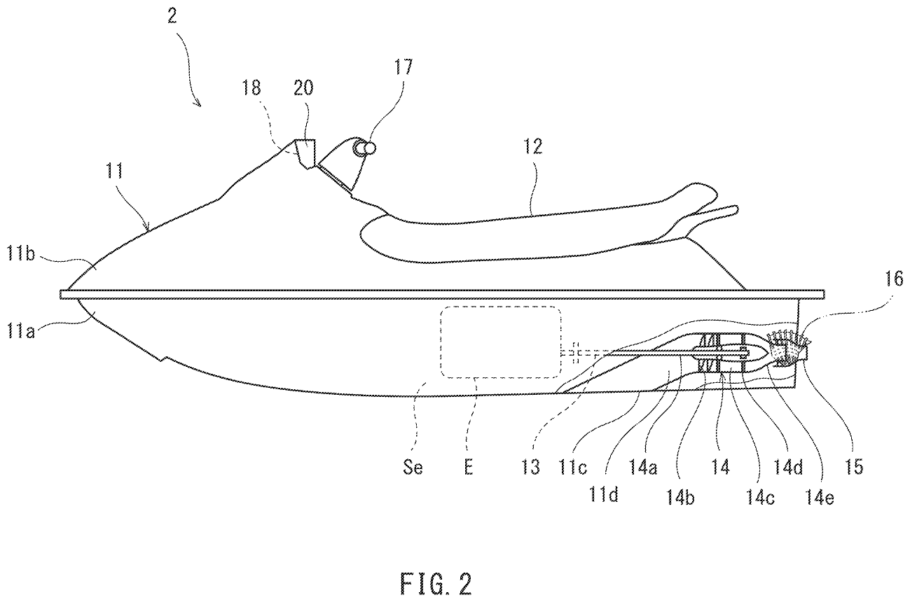

FIG. 2 is a side view showing the PWC 2 and including a partial section. As shown in FIG. 2, the PWC 2 includes a water vehicle body 11, and the water vehicle body 11 includes a hull 11a and a deck 11b that covers the hull 11a from above. A seat 12 on which the user is seated is attached to the deck 11b. There is a prime mover room Se inside the water vehicle body 11. A prime mover E is accommodated in the prime mover room Se of the water vehicle body 11. The prime mover E may be an internal combustion engine, an electric motor, or a combination of an internal combustion engine and an electric motor. An output shaft of the prime mover E is connected to a propeller shaft 13 extending rearward.

A water jet pump 14 is located at a rear portion of the hull 11a. The water jet pump 14 includes: a pump shaft 14a coupled to a rear end portion of the propeller shaft 13; an impeller 14b fixed to the pump shaft 14a; a stator vane 14c located behind the impeller 14b; a pump casing 14d covering the impeller 14b from a radially outer side; and a pump nozzle 14e directed to a rear side of the water vehicle body 11.

A water intake port 11c is open on a bottom portion of the hull 11a. The water intake port 11c communicates with the pump casing 14d through a water intake passage 11d. A steering nozzle 15 is connected to the pump nozzle 14e of the water jet pump 14 so as to be swingable in a left-right direction. A reverse bucket 16 is attached to the hull 11a. The reverse bucket 16 is pivotally supported by the hull 11a so as to be turnable between an advance position at which the reverse bucket 16 covers an ejection port of the steering nozzle 15 from behind to reverse ejected water from the steering nozzle 15 toward a front direction and a retreat position at which the ejection port of the steering nozzle 15 opens toward a rear direction. When the reverse bucket 16 moves to the advance position, the PWC 1 moves rearward. When the reverse bucket 16 moves to the advance position, and the steering nozzle 15 swings to the left or the right, the PWC 1 moves diagonally rearward. To be specific, the PWC 2 may move in any direction.

The PWC 2 pressurizes and accelerates the water, taken in through the water intake port 11c of the bottom portion of the hull 11a, by rotational force of the impeller 14b of the water jet pump 14 driven by the prime mover E. The flow of this water is straightened by the stator vane 14c and is ejected rearward from the pump nozzle 14e through the steering nozzle 15. Thus, propulsive force is generated. The PWC is not limited to a watercraft that is propelled on water by jet water flow generated by the water jet pump. The PWC may be a boat that is propelled on water by the rotation of a propeller.

A bar-shaped handle 17 supported by the deck 11b so as to be turnable is located above a front portion of the deck 11b. When the driver of the PWC 2 turns the handle 17 to the left or the right, the steering nozzle 15 swings to the left or the right in association with the turning operation of the driver. The operation amount of the handle 17 or the steering nozzle 15, i.e., a steering angle may be detected by a steering angle sensor.

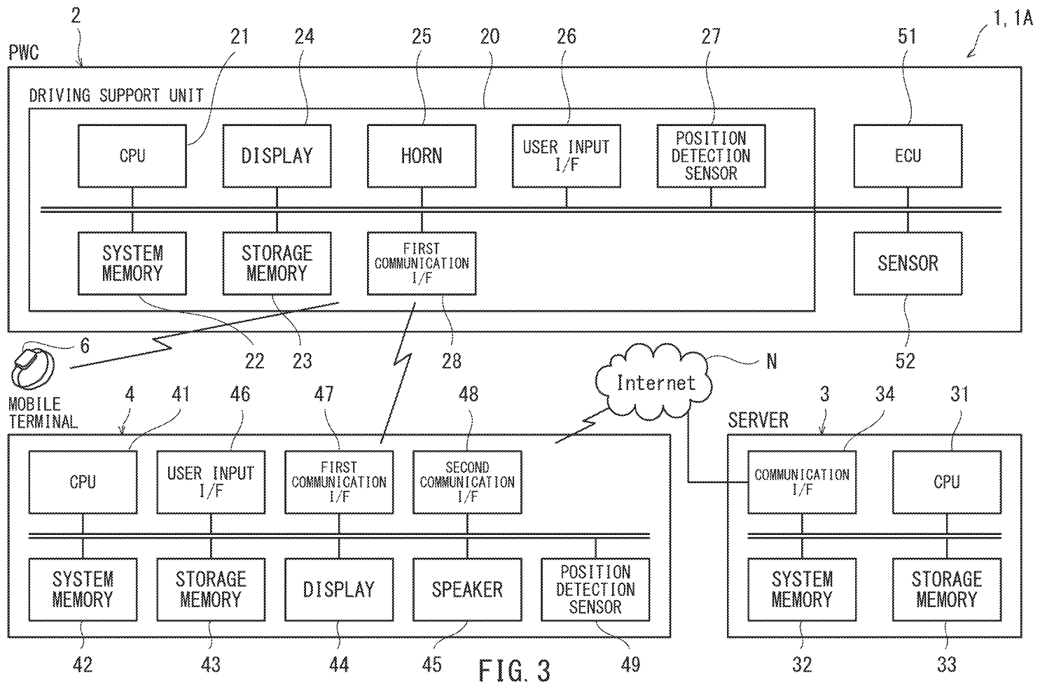

In the present embodiment, the PWC 2 includes a driving support unit 20 that serves as at least a part of the driving support system 1. For example, portions (for example, a display 24; see FIG. 3) of the driving support unit 20 which serve as a user output interface for the driver are located in front of the seat 12. More specifically, the user output interface of the driving support unit 20 may be detachably attached to a unit support 18 of the PWC 2. For example, the unit support 18 is located in front of the handle 17, outside a movable range of the handle 17, and above an upper surface of the seat 12. Parts constituting the driving support unit 20 may be accommodated in one housing or may be separately accommodated in housings. The driving support unit 20 does not have to include a housing.

FIG. 3 is a block diagram showing a driving support system 1A described in the present embodiment. Among the PWCs 2 and the mobile terminals 4, FIG. 3 shows the configuration of one PWC 2 and the configuration of one mobile terminal 4 which moves together with this PWC 2. However, the other PWCs 2 are the same in configuration as the PWC 2 shown in FIG. 3, and the other mobile terminals 4 are the same in configuration as the mobile terminal 4 shown in FIG. 3.

As shown in FIG. 3, the driving support system 1A includes the driving support unit 20. The driving support unit 20 includes: at least one memory storing a PWC program that is at least a part of a driving support program; and at least one processor that can execute the PWC program. Specifically, the driving support unit 20 includes a CPU 21, a system memory 22, a storage memory 23, the display 24, a horn 25, a user input interface 26, a position detection sensor 27, a first communication interface 28, and the like.

The CPU 21 is a central processing unit. The system memory 22 may include a RAM. The storage memory 23 may include a ROM. The ROM stores identification information of the PWC 1. The storage memory 23 may include a hard disk, a flash memory, or a combination thereof. The storage memory 23 stores the PWC program.

The display 24 is one type of user output interface. The display 24 outputs the warning information as a warning image. The display 24 may be a display device, such as a liquid crystal display, an organic EL display, an AR (Augmented Reality) display, or a head mount display, which displays an image for the driver. The display 24 may serve as an instrument panel that displays the states of the PWC 2. For example, the display 24 may display a traveling speed, a fuel remaining amount, a battery remaining amount, and the like as the states of the PWC 2. In addition, as the states of the PWC 2, the display 24 may display environmental information around the PWC 2, such as an outside air temperature and a water temperature. Moreover, as the states of the PWC 2, the display 24 may display traveling states of the PWC 2, such as a proceeding direction and a traveling mode. The CPU 21 may display the states of the PWC 2 on the display 24 based on information given from various sensors 52.

The horn 25 is one type of user output interface and is one type of sound output device that outputs the warning information as warning sound. The horn 25 may be a device that is operated by the driver to output horn sound to the other drivers who drive the other watercrafts. In the present embodiment, each of the display 24 and the horn 25 serves as an informer that outputs driving information necessary to drive the PWC 2 and also outputs the warning information. The PWC 2 may include an indicator or a speaker as the sound output device that outputs the warning information as the warning sound.

The user input interface 26 is an interface through which information operated by the user is input to the CPU 21. The user input interface 26 may be a touch panel of the display 24 or a manipulation element, such as a button or a lever, which is located separately from the display. The user input interface 26 may be a microphone through which information pronounced by the user is input to the CPU 21.

The position detection sensor 27 is a sensor that detects current position coordinates of the PWC 2. The position detection sensor 27 may be a satellite positioning sensor, such as a GPS sensor. The current position coordinates of the PWC 2 may be calculated based on a detected value of a sensor other than the satellite positioning sensor. For example, the current position coordinates of the PWC 2 may be obtained by calculation based on a movement distance calculated from the traveling speed detected by a traveling speed sensor and a movement direction calculated from acceleration detected by a gyro sensor or an IMU.

The first communication interface 28 directly performs wireless communication with the mobile terminal 4 without through a base station. Specifically, the first communication interface 28 can execute near field communication with a first communication interface 47 of the mobile terminal 4. Each of the first communication interface 28 and the first communication interface 47 includes an antenna, a RF (Radio Frequency) circuit, and the like. In the present embodiment, the wireless communication performed by the first communication interface 28 and the first communication interface 47 is Bluetooth (trademark) communication and is realized by pairing. The pairing denotes the execution of mutual authentication by which devices (in the present embodiment, the first communication interface 28 and the first communication interface 47 of the mobile terminal 4) can communicate with each other and are prevented from communicating with unrelated nearby devices. The near field communication performed by the first communication interface 28 is not limited to the Bluetooth (trademark) communication, and another type of noncontact communication system, such as infrared communication, may be adopted. Moreover, a communication system using wired connection of a cable or the like may be adopted.

The first communication interface 28 may be able to perform wireless communication with not only the mobile terminal 4 but also a communication terminal 6 worn by the user M. As described below, for example, the communication terminal 6 may be a device worn by the user M to determine whether or not the user M has fallen into water. For example, the communication terminal 6 may be of a wearable type, such as a smart watch, or may be attached to a life jacket worn by the user M.

In addition to the driving support unit 20, the PWC 2 includes an ECU (Electronic Control Unit) 51, one or more sensors 52, and the like. The ECU 51 is a prime mover controller which includes a processor and a memory and controls the prime mover E and the like based on signals of the sensors 52.

The sensors 52 may include: an accelerator sensor that detects an acceleration requested amount of the driver of the PWC 2; a rotational frequency sensor that detects a rotational frequency of the prime mover E; a remaining amount sensor that detects a remaining amount of an energy source, such as fuel or a battery; a speed sensor that detects the traveling speed of the PWC 2; an acceleration sensor that detects the acceleration of the PWC 2; a gyro sensor that detects the posture of the PWC 2; an inertial measurement unit (IMU) that measures an angular velocity and acceleration of the PWC 2; a sensor that detects the state of the reverse bucket 7; a rear view camera; a front view camera; a temperature sensor that detects a surrounding air temperature or a surrounding water temperature; a sensor that acquires weather; a sensor that acquires the date and time; and any combination thereof. When the prime mover E is an internal combustion engine, the sensors 52 may include: an engine sensor that detects the states (such as a rotational frequency and a warning state) of the engine; an O2 sensor that detects an exhaust state; an intake pressure sensor that detects intake pressure; and the like. The information detected by the sensors 52 may be displayed on the display 24.

The sensors 52 may include a falling detection sensor that detects that the user M has fallen into water from the PWC 2. For example, when the PWC 2 includes a tether cord that connects the water vehicle body of the PWC 2 and the driver, the falling detection sensor may be a separation detection sensor that detects whether or not the tether cord has separated from the water vehicle body of the PWC 2. For example, the falling detection sensor may be a pressure sensitive sensor that is located at the seat 12 and detects whether or not the driver has separated from the seat 12.

The sensors 52 may include a capsizing detection sensor that detects whether or not the PWC 2 has capsized. Whether or not the PWC 2 has capsized can be determined by detecting whether or not the posture of the PWC 2 has turned upside down or whether or not the PWC 2 has inclined at a predetermined angle or more. Therefore, the capsizing detection sensor may be a sensor that detects the posture of the PWC 2. For example, the capsizing detection sensor is realized by using a gyro sensor or a posture detection sensor that utilizes a pendulum.

When the sensors 52 include the falling detection sensor, and the ECU 51 receives sensor information indicating that the user M has fallen into water from the PWC 2, from the falling detection sensor, the ECU 51 may stop the driving of the prime mover E. When the sensors 52 include the capsizing detection sensor, and the ECU 51 receives sensor information indicating that the PWC 2 has capsized, from the capsizing detection sensor, the ECU 51 may stop the driving of the prime mover E. The ECU 51 may stop the driving of the prime mover E in accordance with the operation of the driver of the PWC 2.

The ECU 51, the sensors 52, and various elements included in the driving support unit 20 are connected to each other by CAN (Controller Area Network) communication lines. To be specific, the ECU 51, the sensors 52, the CPU 21, the system memory 22, the storage memory 23, the display 24, the horn 25, the user input interface 26, the position detection sensor 27, and the first communication interface 28 are connected to each other by the CAN communication lines.

### Configuration of Server

The server 3 includes: at least one memory storing a server program that is at least a part of the driving support program; and at least one processor that can execute the server program.

Specifically, the server 3 includes a CPU 31, a system memory 32, a storage memory 33, a communication interface 34, and the like. The CPU 31 is a central processing unit. The system memory 32 may include a RAM. The storage memory 33 is one example of a computer-readable medium and is a non-transitory and tangible medium. The storage memory 33 may include a ROM. The ROM stores the identification information of the PWC 2. The storage memory 33 may include a hard disk, a flash memory, or a combination thereof. The storage memory 33 stores the server program that is at least a part of the driving support program. The communication interface 34 is, for example, a communication board that is connected to the network N through a wire.

The storage memory 33 may include a storage area that stores the positional information of the PWCs 2. For example, the storage memory 33 stores the positional information of the PWC 2 and the identification information of the PWC 2 in association with each other. The positional information of the PWC 2 may be information detected by the position detection sensor 27 of the PWC 2 or may be information detected by a below-described position detection sensor 49 of the mobile terminal 4 that moves together with the PWC 2.

### Configuration of Mobile Terminal

The mobile terminal 4 moves together with the PWC 2 by being carried by the user M of the PWC 2 or by being located at the PWC 2. The mobile terminal 4 includes: at least one memory storing a terminal program that is at least a part of the driving support program; and at least one processor that can execute the terminal program.

Specifically, the mobile terminal 4 includes a CPU 41, a system memory 42, a storage memory 43, a display 44, a speaker 45, a user input interface 46, the first communication interface 47, a second communication interface 48, the position detection sensor 49, and the like.

The CPU 41 is a central processing unit. The system memory 42 may include a RAM. The storage memory 43 is one example of a computer-readable medium and is a non-transitory and tangible medium. The storage memory 43 may include a ROM. The storage memory 43 may include a hard disk and/or a flash memory. The storage memory 43 stores the terminal program.

The display 44 is one type of user output interface. The display 44 outputs the warning information as the warning image. The display 44 may be a display device, such as a liquid crystal display or an organic EL display.

The speaker 45 is one type of sound output device that outputs the warning information as the warning sound. Each of the display 44 and the speaker 45 serves as an informer that outputs the warning information.

The user input interface 46 is an interface to which information is input by the operation of the user. The user input interface 46 may be a touch panel of the display 44, a button, or the like. The user input interface 46 may be a microphone through which information pronounced by the user is input to the CPU 41.

The first communication interface 47 directly performs wireless communication with the PWC 2 (more specifically, the driving support unit 20) without through the base station. Since the first communication interface 47 is the same in configuration as the first communication interface 28, an explanation thereof is omitted.

The second communication interface 48 is wirelessly connected to the network N, such as the Internet, through a public line by a base station antenna that is fixed equipment. Thus, the second communication interface 48 can communicate with the server 3. The second communication interface 48 includes an antenna, a RF (Radio Frequency) circuit, and the like.

The position detection sensor 49 is a sensor that detects the current position coordinates of the mobile terminal 4. The position detection sensor 49 may be a satellite positioning sensor, such as a GPS sensor.

### Driving Support Processing

The following will describe the flow of the driving support processing in the driving support system 1. The driving support processing is performed in such a manner that processing circuitry of the driving support system 1 executes the driving support program. In the present embodiment, the processing circuitry of the driving support system 1 includes the CPU 21 of the PWC 2, the CPU 31 of the server 3, and the CPU 41 of the mobile terminal 4.

Hereinafter, for convenience of explanation, the PWC 2 from which the user has fallen into water and the corresponding mobile terminal 4 are respectively referred to as a warning PWC 2a and a warning terminal 4a, and the PWC 2 which receives a below-described warning request and the corresponding mobile terminal 4 are respectively referred to as a warned PWC 2b and a warned terminal 4b.

However, the warning PWC 2a and the warned PWC 2b are not different from each other in terms of structure. Each PWC 2 may become the warning PWC 2a or the warned PWC 2b depending on the situation. The same is true for the warning terminal 4a and the warned terminal 4b.

The driving support processing in the driving support system 1 includes warning request processing and warning output processing. The warning request processing is mainly executed by the warning PWC 2a and the warning terminal 4a, and the warning output processing is mainly executed by the warned PWC 2b and the warned terminal 4b. A combination of the CPU 21 of the warning PWC 2a and the CPU 41 of the warning terminal 4a is one example of warning processing circuitry. A combination of the CPU 21 of the warned PWC 2b, the CPU 41 of the warned terminal 4b, and the CPU 31 of the server 3 is one example of warned processing circuitry.

### Warning Request Processing

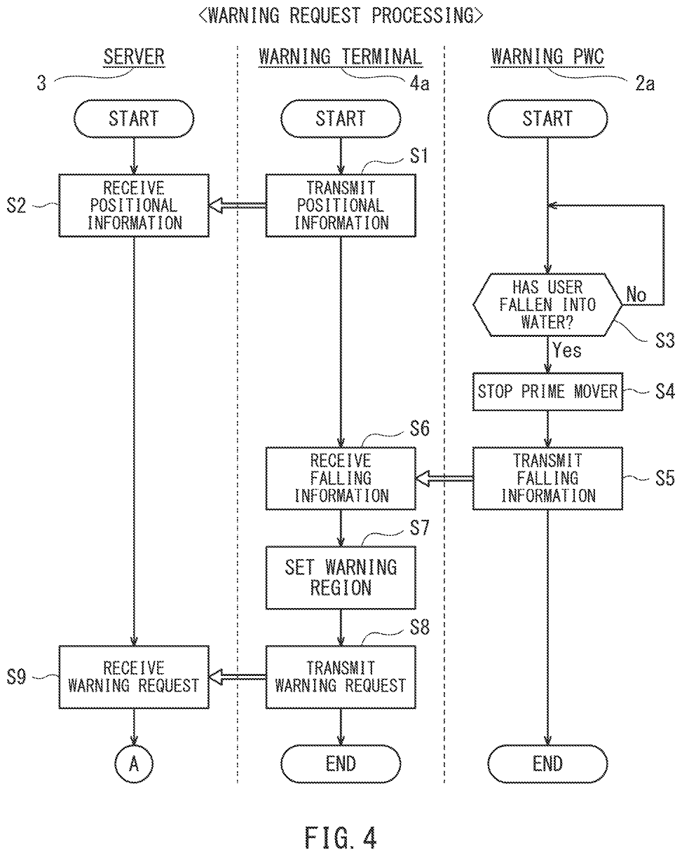

First, the warning request processing will be described with reference to FIG. 4. FIG. 4 is a flowchart showing one example of the warning request processing. FIG. 4 describes only one set including the warning PWC 2a and the warning terminal 4a that moves together with the warning PWC 2a. However, the same processing may be basically performed in all the sets each including the warning PWC 2a and the warned terminal 4b.

For example, the CPU 41 of the warning terminal 4a regularly or irregularly transmits to the server 3 the positional information detected by the position detection sensor 49 (Step S1). The CPU 31 of the server 3 receives the positional information and stores it in the storage memory 33 (Step S2).

FIG. 4 shows the processing of the warning terminal 4a. However, regardless of whether or not the warning terminal is the warning terminal 4a, the CPU 41 of each mobile terminal 4 regularly or irregularly transmits to the server 3 the positional information detected by the position detection sensor 49. Therefore, the pieces of positional information of the mobile terminals 4, in other words, the pieces of positional information of the users M and the PWCs 2 which move together with the mobile terminals 4 are collected in the server 3. The CPU 41 of each mobile terminal 4 may transmit the identification information by which the PWC 2 is identifiable, together with the positional information to the server 3. The server 3 may store the positional information and the identification information in association with each other.

In Step S1, Step T1 described below, or the like, in addition to or instead of the operation of transmitting from the warning terminal 4a to the server 3 the positional information detected by the position detection sensor 49, the positional information detected by the position detection sensor 27 may be transmitted from the warned PWC 2b to the server 3. Moreover, the identification information may be user identification information by which the user who utilizes the PWC 2 is identified.

The CPU 21 of the warning PWC 2a determines whether or not a warning condition has been satisfied. The warning condition is a condition for transmitting the position of a warning point from the warning PWC 2a. When the CPU 21 of the warning PWC 2a determines that the warning condition has been satisfied, the CPU 21 of the warning PWC 2a transmits information indicating the position of the warning point to another watercraft, i.e., the warned PWC 2b.

In the present embodiment, the warning condition is a condition that the user M has fallen into water from the warning PWC 2a. Moreover, the warning point is a position where the user has fallen into water. Therefore, as shown in FIG. 4, the CPU 21 determines whether or not the user M has fallen into water from the warning PWC 2a (Step S3). When the CPU 21 determines that the user M has fallen into water, the CPU 21 determines that the warning condition has been satisfied. A method of determining whether or not the user M has fallen into water (hereinafter may be referred to as falling determination) is not especially limited.

For example, when the sensors 52 include as the falling detection sensor the separation detection sensor that detects whether or not the tether cord connected to the driver has separated from the PWC 2, whether or not the user M has fallen into water may be determined based on the sensor information received from the separation detection sensor.

For example, when the sensors 52 include as the falling detection sensor the pressure sensitive sensor that detects whether or not the driver has separated from the seat 12, whether or not the user M has fallen into water may be determined based on the sensor information received from the pressure sensitive sensor.

For example, when the user M wears the communication terminal 6 that can perform wireless communication with the first communication interface 28 of the PWC 2, whether or not the user M has fallen into water may be determined based on a communication state between the first communication interface 28 and the communication terminal 6 worn by the user Ma who has fallen into water. For example, when the CPU 21 of the warning PWC 2a determines that the communication state between the first communication interface 28 and the communication terminal 6 has become a disconnected state, the CPU 21 of the warning PWC 2a may determine that the user M has fallen into water from the warning PWC 2a. For example, when the CPU 21 of the warning PWC 2a determines that the level of the signal received by the first communication interface 28 from the communication terminal 6 falls below a predetermined value, the CPU 21 of the warning PWC 2a may determine that the user M has fallen into water from the warning PWC 2a. Instead of performing the falling determination based on the communication state between the first communication interface 28 and the communication terminal 6, the falling determination may be performed based on the communication state between the first communication interface 28 and the mobile terminal 4 carried by the user who has fallen into water. The first communication interface 28 is one example of a PWC communicator, and the communication terminal 6 and the mobile terminal 4 are examples of a user communicator.

The condition (hereinafter referred to as a falling condition) that the user M has fallen into water from the warning PWC 2a is one example of the warning condition. The warning condition may be a condition other than the falling condition. The warning condition may be a condition that the PWC 2a has become an abnormal state. For example, the warning condition may be a condition that the PWC 2 has capsized, a condition that the prime mover E that is a traveling driving source has become an inoperative state on water, or a condition that the PWC 2a has become a non-propellable state. In Step S3, the CPU 21 may determine whether or not at least one of these warning conditions has been satisfied. Whether or not the warning condition has been satisfied may be determined based on, for example, the sensor information received from the sensors 52.

When the CPU 21 of the warning PWC 2a determines that the warning condition has been satisfied, specifically in the present embodiment, when the CPU 21 of the warning PWC 2a determines that the user M has fallen into water from the warning PWC 2a (Yes in Step S3), the CPU 21 transmits to the ECU 51 a determination result indicating that the warning condition has been satisfied, i.e., a determination result indicating that the user M has fallen into water from the warning PWC 2a. Then, the ECU 51 urgently stops the prime mover E (Step S4).

Moreover, the CPU 21 transmits to the warning terminal 4a, falling information indicating that the user has fallen into water (Step S5). The falling information includes positional information indicating the falling position X that is the warning point. To be specific, the falling information includes a detected value of the position detection sensor 27 when the user has fallen into water. In addition to the falling position, the falling information may include the identification information of the warning PWC 2a from which the user has fallen into water, the information of the driver of the warning PWC 2a, and the like. For example, the falling information may include below-described user type information.

When the CPU 41 of the warning terminal 4a receives the falling information from the warning PWC 2a (Step S6), the CPU 41 sets the predetermined warning region R including the falling position X (Step S7). Specifically, in Step S7, the CPU 41 sets the warning region R based on the falling position X included in the falling information received in Step S5. The falling position X is one example of the warning point.

For example, in Step S7, instead of setting as the falling position the position detected by the position detection sensor 27 of the PWC 2a, the CPU 41 may set as the falling position X the position detected by the position detection sensor 49 of the terminal 4a when the user has fallen into water. When the detected value of the position detection sensor 49 of the terminal 4a is set as the falling position, the falling information does not have to include the detected value of the position detection sensor 27.

The warning region R is a region which includes the falling position X and is located in the vicinity of the falling position X. For example, the warning region R is a circular region including the falling position X as a center thereof. For example, a radius of the warning region R is 50 meters or more, preferably 80 meters or more.

After Step S7, the CPU 41 of the warning terminal 4a transmits the warning request to the server 3 (Step S8), and the CPU 31 of the server 3 receives the warning request (Step S9).

The warning request includes the falling information regarding the falling of the user into water from the warning PWC 2a. The warning request includes the positional information indicating the falling position X, and may include the positional information indicating the position of the user who has fallen into water.

The warning request includes region information regarding the warning region R set by the CPU 41 in Step S7. The region information is information regarding the size of the warning region R, the shape of the warning region R, the position of the warning region R, or any combination thereof. For example, the region information includes radius information indicating a radius from the falling position X to a boundary of the warning region R. In the present embodiment, the size of the warning region R (in the present embodiment, the radius of the warning region R) is preset. As described below, the warning region R includes an inside warning region and an outside warning region, and the warning request includes the region information of the inside warning region and the region information of the outside warning region.

### Warning Output Processing

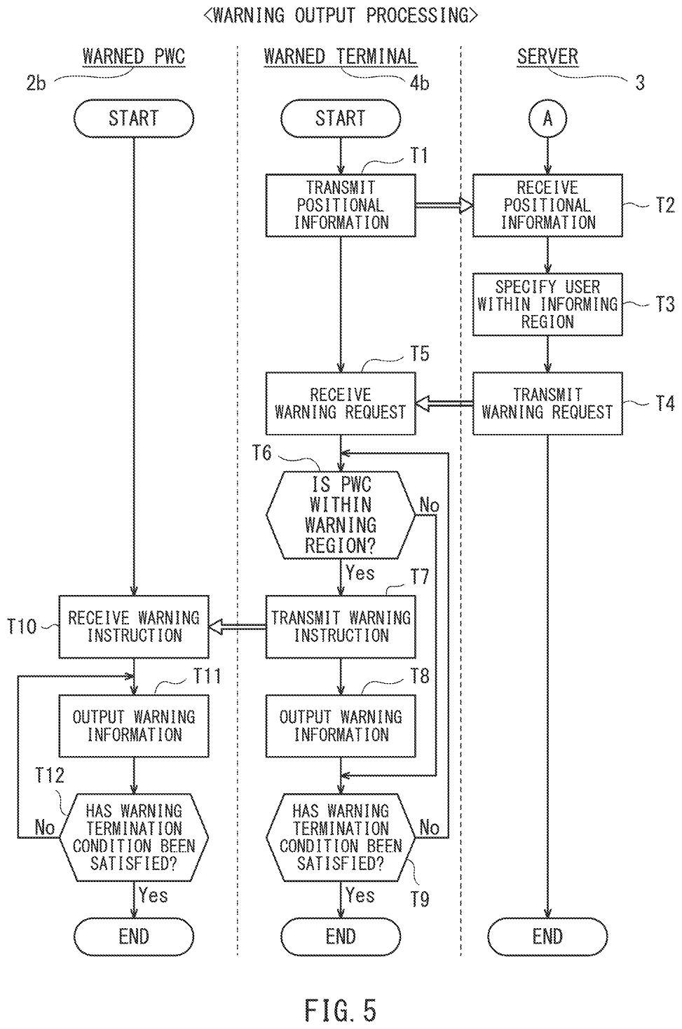

Next, the warning output processing will be described with reference to FIG. 5. FIG. 5 is a flowchart showing one example of the warning output processing. Since Steps T1 and T2 of FIG. 5 are respectively the same as Steps S1 and S2 of FIG. 4, explanations thereof are omitted. FIG. 5 describes only one set including the warned PWC 2b and the warned terminal 4b that moves together with the warned PWC 2b. However, the same processing may be basically performed in all the sets each including the warned PWC 2b and the warned terminal 4b.

After the server 3 receives the warning request, the CPU 31 specifies the user M located within the informing region W, in other words, the PWC 2 located within the informing region W (Step T3).

The informing region W is a region including the falling position X and the warning region R. For example, the informing region W is a circular region including the falling position X as a center thereof. In the present embodiment, the size of the informing region W (in the present embodiment, the radius of the informing region W) is preset. For example, the radius of the informing region W is 10 kilometers or more.

In Step T3, specifically, the CPU 31 sets the informing region W including the falling position X based on the positional information indicating the falling position X shown by the received warning request. The CPU 31 determines whether or not the position of each mobile terminal 4 is within the set informing region W. The CPU 31 specifies all the mobile terminals 4 which have been determined as being within the set informing region W, as transmission targets to which the warning request should be transmitted.

The CPU 31 transmits the warning request to each warned terminal 4b that is the specified transmission target (Step T4). The warning request includes the falling information regarding the falling of the user who has fallen into water from the warning PWC 2a. The warning request includes the positional information indicating the falling position X. As the information, the warning request received by the server 3 in Step S8 of FIG. 4 and the warning request transmitted by the server 3 in Step T8 may be the same as each other or may be different from each other. The warning request may include information other than the falling position X that is the warning point. For example, the warning request may include a warning cause, information regarding the warning PWC, information of the driver of the warning PWC, and the like. Moreover, as described below, the warning request may include user type information indicating the type of the user M who has fallen into water.

When the CPU 41 of the warned terminal 4b receives the warning request (Step T5), the CPU 41 of the warned terminal 4b determines whether or not the warned PWC 2b is within the warning region R (Step T6). When the CPU 41 of the warned terminal 4b determines that the warned PWC 2b is within the warning region R (Yes in Step T6), the CPU 41 of the warned terminal 4b transmits a warning instruction to the warned PWC 2b (Step T7) and outputs the warning information by using the informer of the warned terminal 4b (Step T8).

The warning information output in Step T8 is information for warning the user M that the warned PWC 2b is within the warning region R. In the warned terminal 4b, the warning information is output from the display 44 and the speaker 45. To be specific, the CPU 41 of the warned terminal 4b displays the warning image as the warning information on the display 44 and outputs the warning sound as the warning information from the speaker 45. The warning sound may be a voice message or buzzer sound.

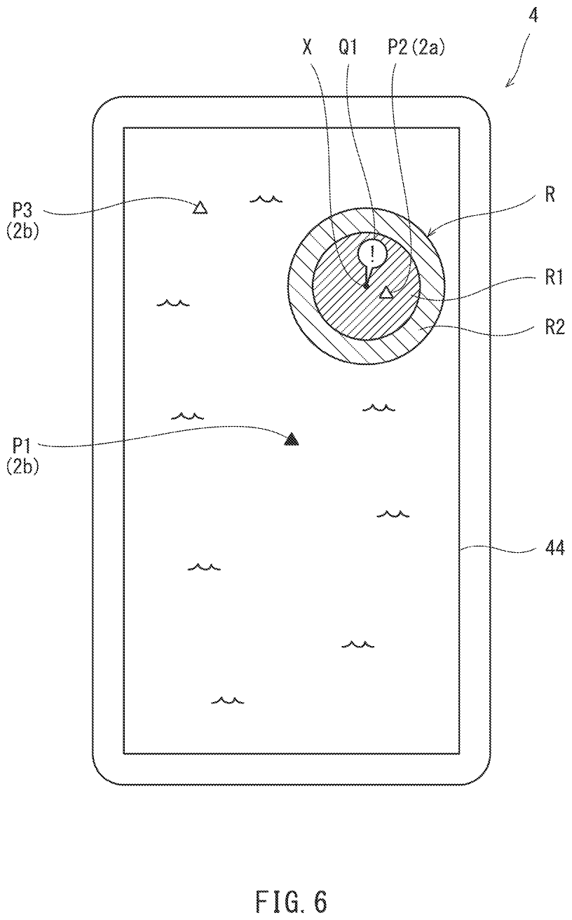

The processing in Steps T5, T6, and T8 in the present embodiment will be described in detail with reference to FIGS. 6 to 8. FIG. 6 is a diagram showing one example of a screen image of the mobile terminal 4. The display 44 displays a map image in which the PWC 2 on which the user M rides and its vicinity are viewed from the sky. Moreover, the display 44 also shows the position of the user M himself/herself who visually recognizes the display 44, i.e., shows a self mark P1 showing the position of the PWC 2 on which the user M rides. Moreover, the display 44 also shows others marks P2 and P3 indicating the positions of the PWCs 2 of the others. Among these, the PWC 2 corresponding to the others mark P2 is the PWC 2 from which the user has fallen into water.

In the present embodiment, when the CPU 41 of the warned terminal 4b receives the warning request in Step T5, the CPU 41 of the warned terminal 4b displays the warning region R on the display 44 as shown in FIG. 6. Therefore, the display 44 shows a positional relation between the self mark P1 of the warned PWC 2b and the warning region R such that the user M can recognize the positional relation. Thus, regardless of whether or not the warned PWC 2b is within the warning region R, the position where the user has fallen into water can be informed to the user M within the informing region W.

When the CPU 41 of the warned terminal 4b receives the warning request in Step T5, the CPU 41 of the warned terminal 4b may transmit the warning request or part of the warning request (for example, the positional information indicating the falling position X or the region information) to the warned PWC 2b. In this case, regardless of whether or not the warned PWC 2b is within the warning region R, the CPU 21 of the warned PWC 2b may display on the display 24 the map image and the warning region R which are shown in FIG. 6.

The falling information included in the warning request may include the user type information indicating the type of the user M who has fallen into water. For example, the user type information is information by which it is possible to determine whether the user who has fallen into water is the driver of the warning PWC 2a or a user other than the driver. The user type information may be information indicating that the user who has fallen into water is the driver of the watercraft, the occupant on the watercraft together with the driver, or a person who has been towed by the watercraft. After the processing circuitry (in the present embodiment, the CPU 41) receives the user type information, the processing circuitry may output the user type information. The user type information may be included in the warning information or may be output together with the output of the warning information. For example, in the screen image of FIG. 6, the display 44 may display information indicating that the user who has fallen into water is the driver or the user other than the driver. For example, when the mobile terminal 4b receives the falling information including the user type information, the CPU 41 may output from the speaker 45 of the mobile terminal 4b the voice message by which the type of the user who has fallen into water can be determined. One example of the voice message is that “A driver has fallen into water from a PWC at a position 100 meters away from here.” When the user type information is output as above, the driver of the watercraft can recognize the type of the user who has fallen into water.

Moreover, the CPU 41 of the warned terminal 4b displays a mark Q1 indicating the falling position X, on the display 44 based on the positional information of the falling position X included in the warning request. Therefore, the display 44 displays the positional relation between the falling position X and the warning region R such that the user M can recognize the positional relation.

In the present embodiment, as shown in FIG. 6, the warning region R includes an inside warning region R1 and an annular outside warning region R2. The inside warning region R1 includes the falling position X and a region around the falling position X. The outside warning region R2 surrounds the inside warning region R1. The inside warning region R1 and the outside warning region R2 are connected to each other by a peripheral edge of the inside warning region R1 and an inner peripheral edge of the outside warning region R2.

For example, the warning request also includes the region information for defining the inside warning region R1 and the outside warning region R2. For example, the region information includes: information indicating the radius of the peripheral edge of the inside warning region R1; and information indicating the radius of an outer peripheral edge of the outside warning region R2. In the present embodiment, the size of the inside warning region R1 (in the present embodiment, the radius of the peripheral edge of the inside warning region R1) and the size of the outside warning region R2 (in the present embodiment, the radius of the outer peripheral edge of the outside warning region R2) are preset.

In Step T6, whether or not the warned PWC 2b is within the inside warning region R1 and whether or not the warned PWC 2b is within the outside warning region R2 are determined. An output content, output form, output method, and the like of the warning information in Step T8 may be changed in accordance with these determination results. To be specific, when it is determined that the warned PWC 2b is within the inside warning region R1, inside warning information may be output as the warning information. When it is determined that the warned PWC 2b is within the outside warning region R2, outside warning information different from the inside warning information may be output as the warning information.

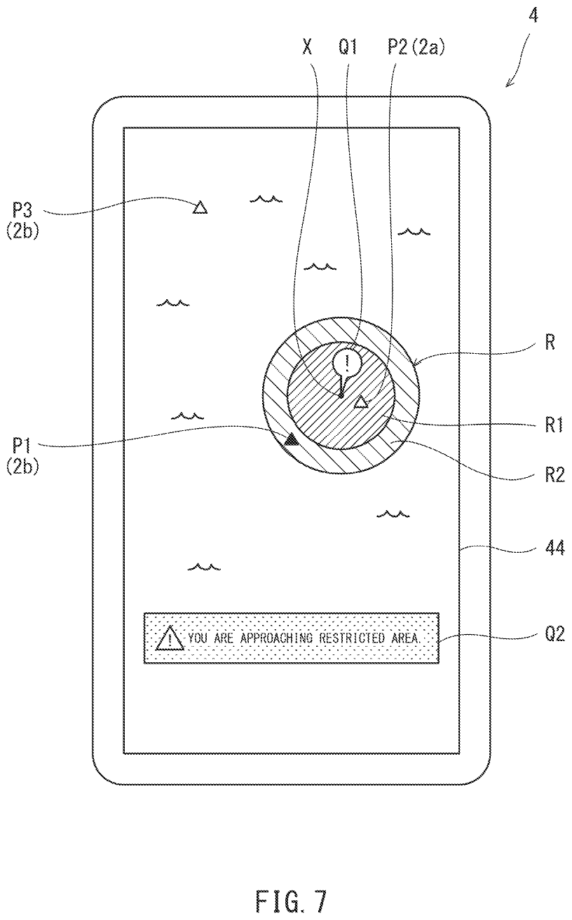

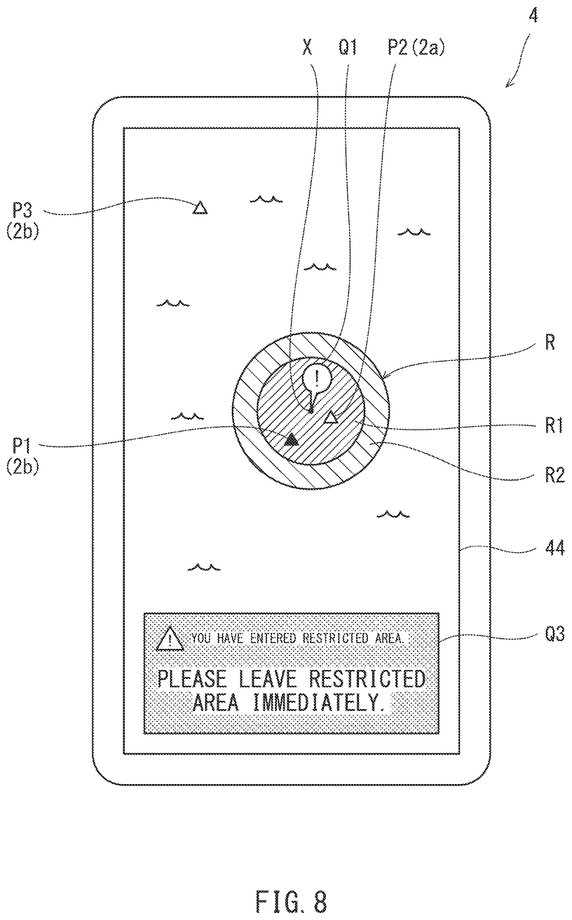

FIG. 7 is an example of the screen image of the mobile terminal 4 when it is determined that the warned PWC 2b is within the outside warning region R2. FIG. 8 is an example of the screen image of the mobile terminal 4 when it is determined that the warned PWC 2b is within the inside warning region R1. As shown in FIG. 7, when it is determined that the warned PWC 2b is within the outside warning region R2, the display 44 displays a warning message Q2 “You are approaching a restricted area” as the outside warning information. As shown in FIG. 8, when it is determined that the warned PWC 2b is within the inside warning region R1, the display 44 displays a warning message Q3 “You have entered the restricted area. Please leave the restricted area immediately” as the inside warning information.

The “restricted area” in the warning messages Q2 and Q3 of FIGS. 7 and 8 denotes the inside warning region R1. Moreover, the contents of the warning messages Q2 and Q3 are merely examples. For example, the content of the warning message Q3 of FIG. 8 is a content that urges the driver to leave the warning region R. However, the content of the warning message Q3 of FIG. 8 may be a content that urges the driver to travel at a slow speed or may be a content that urges the driver to go to the falling position X to rescue the user who has fallen into water. Moreover, the warning information does not have to be displayed as a message. The display mode of the warning information may be a display mode that informs the user that the user is within the warning region R. One example of the display mode of the warning information is a mode in which the screen image blinks on and off.

The degree of warning (in other words, the degree of emphasis) of the output form of the inside warning information is higher than the degree of warning of the output form of the outside warning information.

For example, when both of the inside warning information and the outside warning information are output as the warning image, the degree of emphasis of the displaying of the warning image when it is determined that the warned PWC 2b is within the inside warning region R1 may be made higher than the degree of emphasis of the displaying of the warning image when it is determined that the warned PWC 2b is within the outside warning region R2. For example, the displaying in which the degree of emphasis is made high may be realized by blinking, color change, enlargement, luminance change, text addition, or any combination thereof.

For example, when both of the inside warning information and the outside warning information are output as the warning sound, the degree of emphasis of the output of the warning sound when it is determined that the warned PWC 2b is within the inside warning region R1 may be made higher than the degree of emphasis of the output of the warning sound when it is determined that the warned PWC 2b is within the outside warning region R2. For example, the volume of the warning sound corresponding to the inside warning information may be made larger than the volume of the warning sound corresponding to the outside warning information. For example, the number of times of output of the warning sound corresponding to the inside warning information per unit time may be larger than the number of times of output of the warning sound corresponding to the outside warning information per unit time.

Referring back to FIG. 5, after the warning information is output in Step T8, or when it is determined that the warned PWC 2b is not within the warning region R (No in Step T6), the CPU 41 of the warned terminal 4b determines whether or not a predetermined warning termination condition has been satisfied (Step T9).

When the CPU 41 of the warned terminal 4b determines that the warning termination condition has not been satisfied (No in Step T9), the CPU 41 of the warned terminal 4b returns to Step T6. To be specific, while the warning termination condition is not satisfied, whether or not the warned PWC 2b is within the warning region R is repeatedly determined. When the warned PWC 2b is within the warning region R and while the warning termination condition is not satisfied, the output of the warning information continues.

When the CPU 41 of the warned terminal 4b determines that the warning termination condition has been satisfied (Yes in Step T9), the CPU 41 of the warned terminal 4b terminates the determination regarding whether or not the warned PWC 2b is within the warning region R. When the warning information is being output, the output of the warning information terminates.

For example, the warning termination condition may include a condition that an elapsed time since a predetermined time point (for example, a time point at which the user has fallen into water or a time point at which the warning request is received) after the user has fallen into water has exceeded a set time (for example, ten minutes).

For example, the warning termination condition may include a condition that a warning termination instruction has been received from the warning PWC 2a or the warning terminal 4a. The warning termination instruction is an instruction for prohibiting or stopping the output of the warning information regardless of whether or not the warned PWC 2b is within the warning region R.

For example, when the user input interface 26 of the warning PWC 2a receives the operation of the user M which prohibits or stops the output of the warning information, the CPU 21 may transmit the warning termination instruction to the server 3 through the mobile terminal 4a. Moreover, for example, when the user input interface 46 of the warning terminal 4a receives the operation of the user M which prohibits or stops the output of the warning information, the CPU 41 may transmit the warning termination instruction to the server 3. When the CPU 31 of the server 3 receives the warning termination instruction, the CPU 31 of the server 3 may transmit the warning termination instruction to the transmission target specified in Step T3. Thus, the warning can be prevented from continuing undesirably.

In other words, the warning termination instruction is an instruction to invalidate the warning region R. As above, the processing circuitry of the driving support system 1 may be configured to be able to switch whether to validate or invalidate the warning region R in accordance with the operation of the user.

The warning termination instruction may be transmitted from the warning PWC 2a through the warning terminal 4a to the server 3 or may be directly transmitted to the server 3 without through the warning terminal 4a (for example, through a below-described second communication interface 29). When the user input interface 46 of the warning terminal 4a receives the operation of the user M which prohibits the output of the warning information, the CPU 41 may transmit the warning termination instruction to the server 3 through the second communication interface 48.

When the CPU 21 of the warned PWC 2b receives the warning instruction transmitted from the warned terminal 4b in Step T7 (Step T10), the CPU 21 of the warned PWC 2b outputs the warning information by using the informer of the warned PWC 2b (Step T11).

As with Step T8, the warning information output in Step T11 is information for warning the user M that the warned PWC 2b is within the warning region R. In the warned PWC 2b, the warning information is output from the display 24 that serves as the instrument panel and the horn 25 that is located as a device that generates the horn sound to the other drivers. To be specific, the CPU 21 of the warned PWC 2b displays the warning image as the warning information on the display 24 and outputs the warning sound as the warning information from the horn 25. The warning image displayed on the display 24 is the same as the warning image displayed on the display 44 shown in FIG. 7 or 8. The display mode of the warning image may be different between the display 24 of the PWC 2 and the display 44 of the mobile terminal 4.

After the warning information is output in Step T11, the CPU 21 of the warned PWC 2b determines whether or not a predetermined warning termination condition has been satisfied (Step T12). When the CPU 21 of the warned PWC 2b determines that the warning termination condition has not been satisfied (No in Step T12), the CPU 21 of the warned PWC 2b returns to Step T11. To be specific, while the warning termination condition is not satisfied, the output of the warning information continues. When the CPU 21 of the warned PWC 2b determines that the warning termination condition has been satisfied (Yes in Step T12), the CPU 21 of the warned PWC 2b terminates the output of the warning information.

The warning termination condition in Step T12 may be the same as or different from the warning termination condition in Step T9. For example, the warning termination condition may include a condition that an elapsed time since a predetermined time point after the user has fallen into water has exceeded a set time. For example, the warning termination condition may include a condition that the warning termination instruction has been received from the warning PWC 2a or the warning terminal 4a.

According to the above-described configuration, the output of the warning information can make the user recognize that the user is driving within the warning region R. Thus, the driving of the user can be supported. For example, the driving operation of the user of the warned PWC 2b can be supported such that the warned PWC 2b does not approach the user who has fallen into water, or the warned PWC 2b slowly travels to rescue the user who has fallen into water.

Moreover, in the present embodiment, the warning information that is output when the warned PWC 2b is within the inside warning region R1 and the warning information that is output when the warned PWC 2b is within the outside warning region R2 are different from each other. Therefore, the user can easily recognize how close to the falling position X that is the warning point the watercraft on which the user rides is located. Thus, the convenience of the user improves.

Moreover, in the present embodiment, the degree of warning of the output form of the inside warning information is higher than the degree of warning of the output form of the outside warning information. Therefore, when the warned PWC 2b is within the inside warning region R1, the user can be warned more strongly. Thus, for example, the warned PWC 2b is easily prevented from approaching the falling position X.

Moreover, in the present embodiment, since the warning information is output by using the informer mounted on the warned PWC 2b, the user of the warned PWC 2b easily recognizes the warning.

### Modified Example of Driving Support System

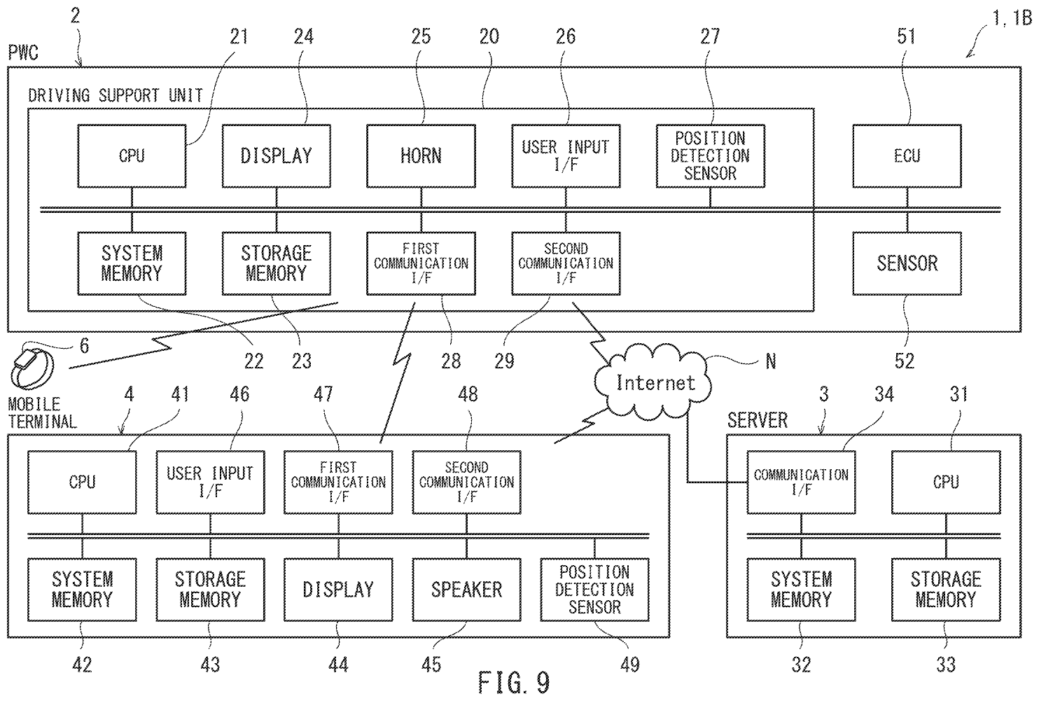

FIG. 9 is a block diagram showing a modified example of the driving support system 1. A driving support system 1B shown in FIG. 9 is different from the driving support system 1A shown in FIG. 4 in that the PWC 2 includes the second communication interface 29.

The second communication interface 29 is wirelessly connected to the network N, such as the Internet, through a public line by a base station antenna that is fixed equipment. Thus, the second communication interface 29 can communicate with the server 3. The second communication interface 29 includes an antenna, a RF (Radio Frequency) circuit, and the like.

To be specific, in the driving support system 1B, the PWC 2 can communicate with the server 3 without through the mobile terminal 4. Thus, the PWC 2 does not necessarily have to communicate with the server 3 and the other PWCs through the mobile terminal 4.

### Modified Example of Warning Request Processing

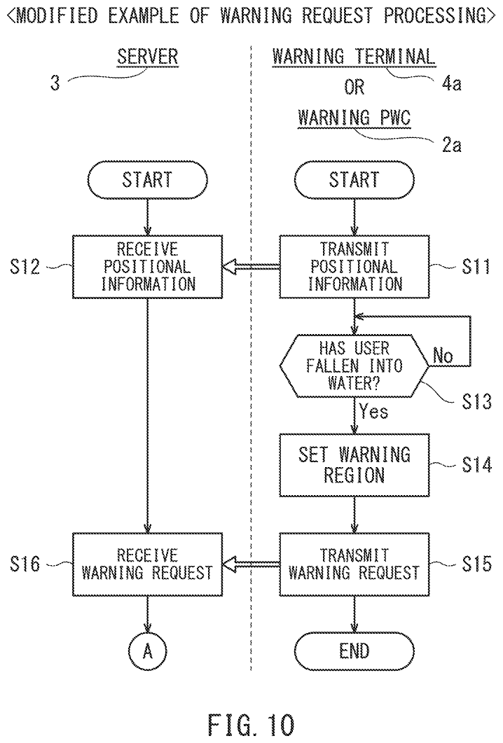

FIG. 10 is a flowchart showing a modified example of the warning request processing. In the warning request processing shown in FIG. 4, the falling determination is performed by the PWC 2, and the transmission of the warning request to the other users is performed by the mobile terminal 4. However, as shown in FIG. 10, both of the falling determination and the transmission of the warning request to the other users may be performed by only one of the PWC 2 and the mobile terminal 4.

Since Steps S11, S12, S13, S14, S15, and S16 shown in FIG. 10 respectively correspond to and are the same as Steps S1, S2, S3, S6, S7, and S8 shown in FIG. 4, explanations thereof are omitted.

When the CPU 41 of the warning terminal 4a executes Steps S11, S13, S14, and S15, the CPU 41 may perform the falling determination regarding whether or not the user M has fallen into water, based on, for example, the communication state between the mobile terminal 4a carried by the user M and the first communication interface 28. The falling determination method based on the communication state between the mobile terminal 4a and the first communication interface 28 is the same as the above falling determination method based on the communication state between the first communication interface 28 and the communication terminal 6.

When the CPU 21 of the warning PWC 2a executes Steps S11, S13, S14, and S15, the CPU 21 transmits the warning request to the server 3 without through the mobile terminal 4a. In this case, when the CPU 21 determines in Step S13 that the user M has fallen into water from the warning PWC 2a (Yes in Step S13), the prime mover E may be urgently stopped as with Step S4 of FIG. 4.

According to the modified example of the warning request processing, the warning request can be transmitted without the communication between the mobile terminal 4a and the warning PWC 2a.

### Modified Example 1 of Warning Output Processing

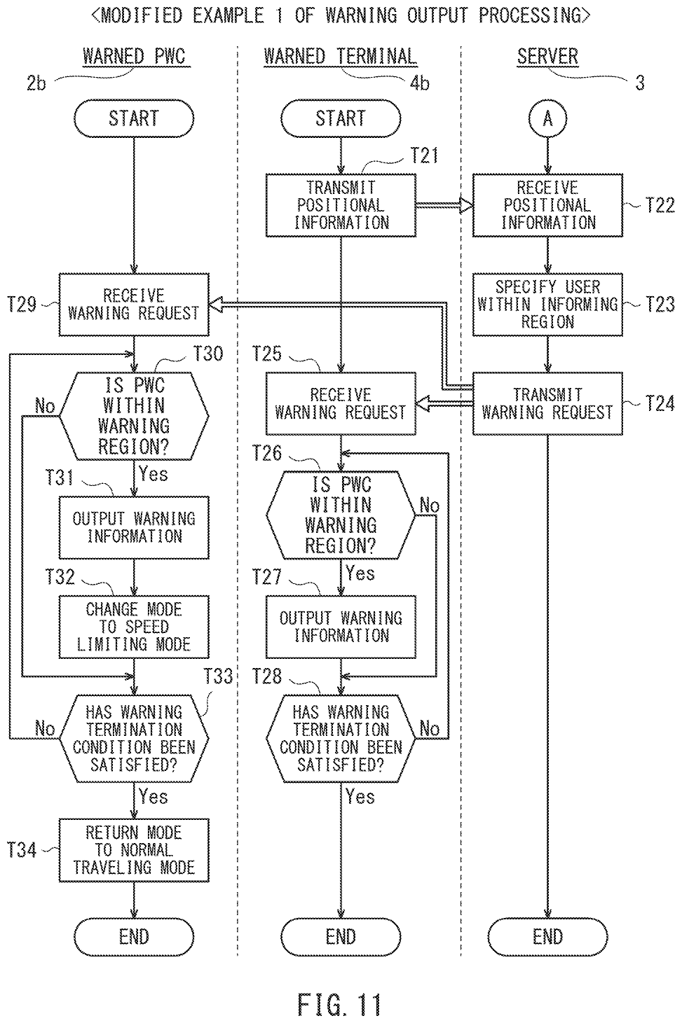

FIG. 11 is a flowchart showing Modified Example 1 of the warning output processing. In the warning output processing shown in FIG. 5, whether or not the warned PWC 2b is within the warning region R is determined by the warned terminal 4b and is not determined by the warned PWC 2b. As shown in FIG. 11, whether or not the warned PWC 2b is within the warning region R may be determined by each of the warned terminal 4b and the warned PWC 2b. The warning output processing of Modified Example 1 may be executed by using the driving support system 1B shown in FIG. 9.

Since Steps T21, T22, and T23 shown in FIG. 11 are the same as Steps T1, T2, and T3 shown in FIG. 5, explanations thereof are omitted. In Step T21, instead of the transmission of the positional information, which has been detected by the position detection sensor 49, to the server 3 by the CPU 41 of the warning terminal 4a, the CPU 21 of the warned PWC 2b may transmit to the server 3 the positional information detected by the position detection sensor 27.

After the CPU 31 specifies the user M within the informing region W in Step T23, the CPU 31 transmits the warning request to the warned terminal 4b of the specified user M and also transmits the warning request to the warned PWC 2b of the specified user M (Step T24).

In the processing after the time point at which the warned terminal 4b has received the warning request, Steps T25, T26, T27, and T28 shown in FIG. 11 are respectively the same as Steps T5, T6, T8, and T9 shown in FIG. 5, and therefore, explanations thereof are omitted.

When the CPU 21 of the warned PWC 2b receives the warning request (Step T29), the CPU 21 of the warned PWC 2b determines whether or not the warned PWC 2b is within the warning region R (Step T30). When the CPU 21 of the warned PWC 2b determines that the warned PWC 2b is within the warning region R (Yes in Step T30), as with Step T11 of FIG. 4, the CPU 21 of the warned PWC 2b outputs the warning information by using the informer of the warned PWC 2b (Step T31).

Moreover, when the CPU 21 of the warned PWC 2b determines that the warned PWC 2b is within the warning region R, the CPU 21 of the warned PWC 2b changes a control mode of controlling the prime mover E that is the traveling driving source of the warned PWC 2b, from a normal traveling mode to a speed limiting mode (Step T32).

To be specific, depending on whether or not the warned PWC 2b is within the warning region R, the CPU 21 changes the control mode of controlling the prime mover E that is the traveling driving source of the warned PWC 2b. Specifically, when the CPU 21 determines that the warned PWC 2b is not within the warning region R, the CPU 21 sets the control mode to the normal traveling mode. When the CPU 21 determines that the warned PWC 2b is within the warning region R, the CPU 21 sets the control mode to the speed limiting mode. The speed limiting mode is a mode that limits a maximum speed such that the maximum speed becomes lower than a maximum speed when the control mode is the normal traveling mode.

As above, the control mode is set to the speed limiting mode when the warned PWC 2b is within the warning region R. Therefore, regardless of whether or not the user of the warned PWC 2b recognizes that the warned PWC 2b is within the warning region R, the warned PWC 2b can be prevented from traveling at high speed in the vicinity of the warning point.

After Step T32, as with Step T12, the CPU 21 of the warned PWC 2b determines whether or not a predetermined warning termination condition has been satisfied (Step T33). When the CPU 21 of the warned PWC 2b determines that the warning termination condition has not been satisfied (No in Step T32), the CPU 21 of the warned PWC 2b returns to Step T30. To be specific, while the warning termination condition is not satisfied, the output of the warning information continues, and the speed limiting mode continues. When the CPU 21 of the warned PWC 2b determines that the warning termination condition has been satisfied (Yes in Step T33), the CPU 21 terminates the output of the warning information and returns the control mode to the normal traveling mode from the speed limiting mode (Step T34).

In Step T30, as with Step T6, whether or not the warned PWC 2b is within the inside warning region R1 and whether or not the warned PWC 2b is within the outside warning region R2 may be determined. In this case, when it is determined that the warned PWC 2b is within the inside warning region R1, the control mode may be set to a first speed limiting mode. Moreover, when it is determined that the warned PWC 2b is within the outside warning region R2, the control mode may be set to a second speed limiting mode. The first speed limiting mode may be a mode in which the maximum speed is limited so as to be lower than the maximum speed when the control mode is the second speed limiting mode. To be specific, the maximum speed of the warned PWC 2b may be made lower as the warned PWC 2b approaches the warning point.

According to Modified Example 1 of the warning output processing, the warning information can be output without the communication between the mobile terminal 4a and the warning PWC 2a. One of the determination result of the mobile terminal 4a and the determination result of the warning PWC 2a does not influence the other. Therefore, for example, even when the mobile terminal 4a does not function due to battery exhaustion, the PWC can output the warning information.

In Modified Example 1 of the warning output processing, Steps T32 and T34 may be omitted. In Modified Example 1 of the warning output processing, the warning request may be transmitted to only one of the warned terminal 4b and the warned PWC 2b in Step T24. In this case, Steps T25, T26, T27, and T28 may be omitted, or Steps T29, T30, T31, T32, T33, and T34 may be omitted.

### Modified Example 2 of Warning Output Processing

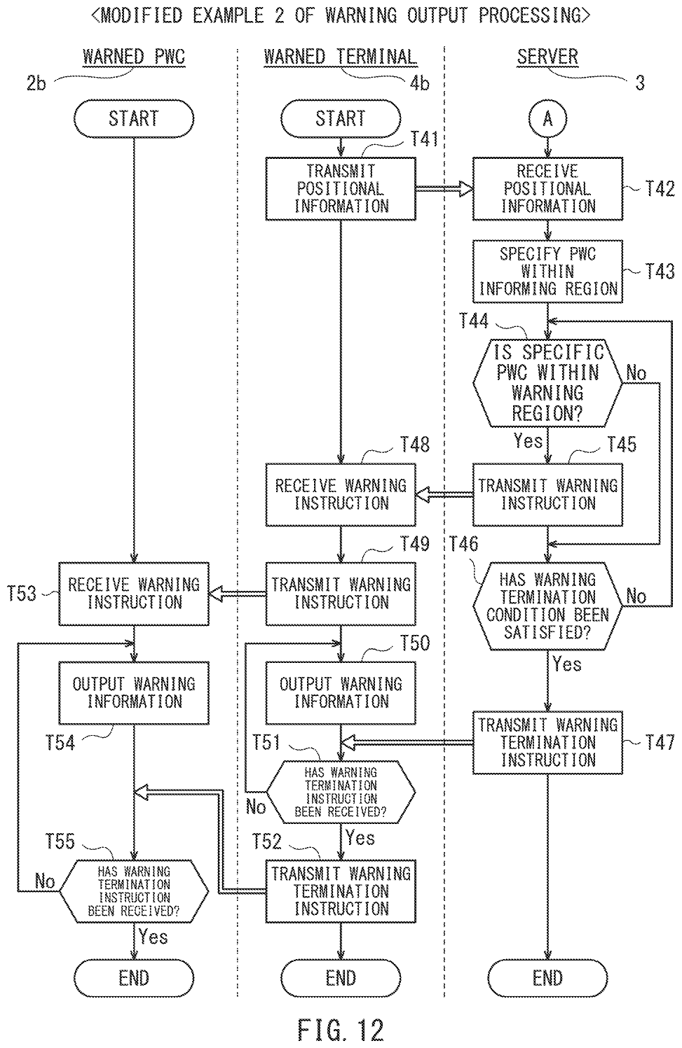

FIG. 12 is a flowchart showing Modified Example 2 of the warning output processing. In the warning output processing shown in FIG. 5, whether or not the warned PWC 2b is within the warning region R is determined by the warned terminal 4b. However, as shown in FIG. 12, in the processing of Modified Example 2, whether or not the warned PWC 2b is within the warning region R may be determined by the server 3.

Since Steps T41, T42, and T43 shown in FIG. 12 are the same as Steps T1, T2, and T3 shown in FIG. 5, explanations thereof are omitted. After the CPU 31 has specified the user M within the informing region W in Step T43, as with Step T6, the CPU 31 determines whether or not the warned PWC 2b is within the warning region R (Step T44). When the CPU 31 of the server 3 determines that the warned PWC 2b is within the warning region R (Yes in Step T44), the CPU 31 of the server 3 transmits the warning instruction to the warned terminal 4b (Step T45).

After the CPU 31 of the server 3 transmits the warning instruction in Step T45, or when the CPU 31 of the server 3 determines that the warned PWC 2b is not within the warning region R (No in Step T44), the CPU 31 of the server 3 determines whether or not a predetermined warning termination condition has been satisfied (Step T46).

When the CPU 31 of the server 3 determines that the warning termination condition has not been satisfied (No in Step T46), the CPU 31 of the server 3 returns to Step T44. To be specific, while the warning termination condition is not satisfied, whether or not the warned PWC 2b is within the warning region R is repeatedly determined. When the warned PWC 2b is within the warning region R and while the warning termination condition is not satisfied, the transmission of the warning instruction continues. The transmission of the warning instruction may be performed only once after it is determined for the first time that the warned PWC 2b is within the warning region R.

When the CPU 31 of the server 3 determines that the warning termination condition has been satisfied (Yes in Step T46), the CPU 31 of the server 3 terminates the determination regarding whether or not the warned PWC 2b is within the warning region R, and transmits the warning termination instruction to the warned terminal 4b (Step T47).

When the CPU 41 of the warned terminal 4b receives the warning instruction (Step T48), the CPU 41 of the warned terminal 4b transmits the warning instruction to the warned PWC 2b (Step T49) and outputs the warning information by using the informer of the warned terminal 4b (Step T50).

Moreover, the CPU 41 of the warned terminal 4b determines whether or not the CPU 41 of the warned terminal 4b has received the warning termination instruction (Step T51). When the CPU 41 of the warned terminal 4b determines that the CPU 41 of the warned terminal 4b has not received the warning termination instruction (No in Step T51), the CPU 41 of the warned terminal 4b returns to Step T50. To be specific, the output of the warning information continues until the CPU 41 of the warned terminal 4b receives the warning termination instruction. When the CPU 41 of the warned terminal 4b determines that the CPU 41 of the warned terminal 4b has received the warning termination instruction (Yes in Step T51), the CPU 41 of the warned terminal 4b transmits the warning termination instruction to the warned PWC 2b (Step T52) and terminates the output of the warning information.

When the CPU 21 of the warned PWC 2b receives the warning instruction (Step T53), the CPU 21 of the warned PWC 2b outputs the warning information by using the informer of the warned PWC 2b (Step T54).

Moreover, the CPU 21 of the warned PWC 2b determines whether or not the CPU 21 of the warned PWC 2b has received the warning termination instruction (Step T55). When the CPU 21 of the warned PWC 2b determines that the CPU 21 of the warned PWC 2b has not received the warning termination instruction (No in Step T55), the CPU 21 of the warned PWC 2b returns to Step T54. To be specific, the output of the warning information continues until the CPU 21 of the warned PWC 2b receives the warning termination instruction. When the CPU 21 of the warned PWC 2b determines that the CPU 21 of the warned PWC 2b has received the warning termination instruction (Yes in Step T55), the CPU 21 of the warned PWC 2b terminates the output of the warning information.

According to Modified Example 2 of the warning output processing, since the processing of determining whether or not the warned PWC 2b is within the inside warning region R1 is executed by the server 3, the processing in the mobile terminal 4a or the warning PWC 2a can be simplified.

In Steps T51 and T55, as with Steps T9 and T11, whether or not the warning termination condition has been satisfied may be determined.

Moreover, in Step T45, the warning instruction may be transmitted from the server 3 to not only the warned terminal 4b but also the warned PWC 2b or may be transmitted from the server 3 only to the warned PWC 2b. In this case, Steps T49 and T52 are omitted, and the same steps as Steps T48, T50, and T51 of the warned terminal 4b may be performed in the warned PWC 2b.

### Other Embodiments

The present disclosure is not limited to the above embodiment, and various modifications may be made within the scope of the present disclosure.

The methods and configurations of the present disclosure are applicable to watercrafts other than personal watercrafts. Examples of the watercrafts include: boats, such as small motorboats and sailboats; and yachts. As a propulsion system of the watercraft, a jet propulsion system or a propeller propulsion system may be adopted. The driving source of the watercraft may be an internal combustion engine or an electric motor. When the watercraft is a yacht, the driving source does not have to be included. It is preferable that the driving support method and driving support system of the present disclosure be used especially for the driving support of pleasure boats used for recreation traveling on the sea.

Moreover, the methods and configurations of the present disclosure are applicable to moving machines other than watercrafts. For example, the methods and configurations of the present disclosure may be used for land moving machines. Among the land moving machines, the driving support method and driving support system of the present disclosure may be especially preferably utilized for all-terrain vehicles. This is because since the degrees of freedom of traveling directions and routes of the all-terrain vehicles are high, the necessity of the support is high. One example of the all-terrain vehicles is a utility vehicle. Moreover, the driving support method and driving support system of the present disclosure are preferably used for moving machines for recreation traveling on uneven ground, such as four-wheeled vehicles, straddled four-wheeled buggy cars called ATVs, and off-road two-wheeled vehicles as the all-terrain vehicles. When the methods and configurations of the present disclosure are used for the all-terrain vehicle, a position where the driver has separated from the all-terrain vehicle, a position where the all-terrain vehicle has been overturned, or the like may be set as the warning point.

For example, the flow of the processing shown in each of the embodiments and the modified examples is merely one example. For example, in the warning request processing shown in FIG. 4, the CPU 41 of the warning terminal 4a sets the warning region R. However, instead of the CPU 41 of the warning terminal 4a, the warning region R may be set by the CPU 31 of the server 3, the CPU 41 of the warned terminal 4b, the CPU 21 of the warned PWC 2b, the CPU 21 of the warning PWC 2a, or the like. For example, when the warning region R is set by the server 3 or the warned terminal 4b, the warning request transmitted to the server 3 or the warned terminal 4b does not have to include the region information regarding the warning region R. The warning request may include the positional information of the warning point.

The steps shown in FIGS. 4, 5, 10, 11, and 12 may be suitably combined with each other. For example, the steps of changing the control mode which correspond to Steps T31 and T34 of FIG. 11 may be incorporated in the warning output processing of FIGS. 5 and 12. When the warning instruction is received by the PWC, the CPU of the PWC may change the control mode from the normal traveling mode to the speed limiting mode.

The mobile terminal 4 does not have to be a smartphone and may be another type of mobile computer, such as a tablet PC (Personal Computer), a notebook PC, or a special device used to utilize the driving support system.

In the above embodiment, the processing circuitry of the driving support system 1 includes the CPU 21 of the PWC 2, the CPU 31 of the server 3, and the CPU 41 of the mobile terminal 4. However, the processing circuitry of the driving support system is not limited to this.

For example, the PWC 2a of the user who has fallen into water or the mobile terminal 4a of the user who has fallen into water may transmit the warning request to the other PWCs without through the server. For example, the PWC 2a of the user who has fallen into water or the mobile terminal 4a of the user who has fallen into water may transmit the warning request to the other mobile terminals 4b without through the server. The processing circuitry of the driving support system 1 which is configured to execute the processing described in the present disclosure may be circuitry mounted on any one of the PWC, the server, and the mobile terminal.

When the direct communication between the watercrafts can be realized by communicators mounted on the watercrafts or when the communication between the watercraft and the server can be realized by a communicator mounted on the watercraft, the driving support system does not have to include the mobile terminal. In this case, various types of processing which are descried in the above embodiments and the above modified examples and are executed by the mobile terminal may be executed by the watercraft or the server.

When the communication between the watercrafts can be realized without through the server, or when the communication between the mobile terminals can be realized without through the server, the driving support system does not have to include the server. In this case, various types of processing which are described in the above embodiments and the above modified examples and are executed by the server may be executed by the watercraft or the mobile terminal.

For example, the configurations of the devices (such as the moving machine, the server, and the mobile terminal) included in the driving support system may be changed in accordance with the details of the processing of the driving support system. For example, when the detected value of the position detection sensor mounted on the mobile terminal is used as the positional information of the warning point included in the warning request, the moving machine does not have to include the position detection sensor. As in the warning request processing shown in FIG. 10, the warning output processing shown in FIG. 11, and the like, the moving machine and the mobile terminal do not have to communicate with each other in the driving support system. In this case, each of the moving machine and the mobile terminal does not have to include a communicator (for example, the first communication interface 28 or the first communication interface 47 in the above embodiment) for the communication therebetween. When the server and the PWC do not directly communicate with each other as in the warning output processing shown in FIG. 12, the PWC does not have to include the second communication interface 29.

The processing circuitry of the driving support system may execute only one of the warning request processing and the warning output processing. In other words, the processing circuitry of the driving support system may include only one of the warning processing circuitry that executes the warning request processing and the warned processing circuitry that executes the warning output processing. The warning processing circuitry may be one of circuitry of the warning watercraft and circuitry of the warning terminal. The warned processing circuitry may be one of circuitry of the warned watercraft and circuitry of the warned terminal.

In the present disclosure, the expression “an element located at the watercraft” may denote that the element is mounted on the watercraft, or the element is mounted on the mobile terminal of the user who is on the watercraft. For example, the display located at the warned watercraft may be the display attached to the warned watercraft or the display of the mobile terminal that moves together with the warned watercraft.

The warning region R does not have to have a circular shape and may have, for example, a polygonal shape. Similarly, the informing region W does not have to have a circular shape and may have, for example, a polygonal shape.

In the above embodiment, one warning point is set when it is determined that the warning condition has been satisfied. However, the above embodiment is not limited to this, and the warning points may be set. For example, the processing circuitry may set both of the falling position and the current position of the warning PWC as the warning positions. For example, the processing circuitry may set both of the position of the user who has fallen into water and the current position of the warning PWC as the warning positions. When the processing circuitry sets the warning points, the processing circuitry may set the warning points such that warning regions corresponding to the warning points overlap each other.

The processing circuitry may set the warning region corresponding to the situation. For example, the processing circuitry may change the size and shape of the warning region depending on the situation.

For example, the processing circuitry may set the warning region corresponding to a falling situation. For example, the processing circuitry may set the warning region such that the size of the warning region set when the user has fallen into water during the traveling of the PWC is made larger than the size of the warning region set when the user has fallen into water during the stop state of the PWC.

For example, the processing circuitry may set the warning region corresponding to the situation around the PWC. For example, the processing circuitry may set the warning region such that the size of the warning region set when the PWC is in a specific region, such as a low visibility region or a region where the flow of the water or wind is strong, is made larger than the size of the warning region set when the PWC is not in the specific region.

For example, the processing circuitry may set the warning region based on information detected by a sensor mounted on the PWC, information received through the Internet, or the like such that the warning region has an oval shape extending from the falling position along the flow of the water or wind.

For example, the processing circuitry may change the size of the warning region in accordance with the state of the warned PWC. For example, the processing circuitry may set the warning region corresponding to the traveling speed or traveling ability of the warned PWC. The processing circuitry may change the size of the warning region in accordance with whether the warned PWC is in a traveling state or an idling state.

A display time of the warning region may be limited. In this case, the processing circuitry may change the display time of the warning region depending on the situation.

The warning termination condition may change depending on the situation. When the warning termination condition includes a condition that an elapsed time since a predetermined time point (for example, a time point at which the user has fallen into water or a time point at which the warning request is received) after the user has fallen into water exceeds a set time, the set time may change depending on the situation.

The example of the screen image shown in FIG. 6 displays both of the inside warning region R1 and the outside warning region R2 which are included in the warning region R. However, only the inside warning region R1 may be displayed.

The warning request includes the region information of the inside warning region and the region information of the outside warning region. However, the warning request may include only one of the region information of the inside warning region and the region information of the outside warning region. The warning request does not have to include the region information. The warning request may include the positional information of the warning point.

In the above embodiment, the size of the warning region is preset. However, the size of the warning region may be able to be set by the user. Both of the size of the inside warning region and the size of the outside warning region may be able to be set by the user. Or, one of the size of the inside warning region and the size of the outside warning region may be able to be set by the user. For example, the size of the outside warning region may be able to be set by the user. In this case, the user who sets the size of the warning region may be a user who transmits the warning request or may be a user who receives the warning request.

The processing circuitry may change the size and shape of the informing region depending on the situation. Moreover, the size of the informing region is preset. However, the size of the informing region may be able to be set by the user.

The output content, output form, output method, and the like of the warning information may be able to be set by the user. For example, whether to display the outside warning region R2 may be able to be set by the user. Whether to output only sound information, only image information, or both of the sound information and the image information as the warning information may be able to be set by the user. The user who performs such setting may be a user who transmits the warning request or may be a user who receives the warning request.

In the above embodiment, the warning region R includes two sub regions that are the inside warning region R1 and the outside warning region R2. However, the above embodiment is not limited to this. For example, the warning region R may include only one region. For example, the warning region R may include only a region corresponding to the inside warning region R1. For example, the warning region R may include three or more sub regions. In this case, the output content, output form, output method, and the like of the warning information may change depending on the sub region in which the PWC is located.

In the above embodiment, the mobile terminal 4 and the PWC 2 which have been determined as being located within the informing region W are the transmission targets of the warning request. However, the transmission targets of the warning request are not limited to these.

A condition for selecting the PWC or the mobile terminal as the transmission target of the warning request may be set. For example, the processing circuitry may select the PWC or the mobile terminal which is moving at a predetermined speed or more, as the transmission target to which the warning request should be transmitted. For example, when the server selects the transmission target to which the warning request should be transmitted, the server may calculate the movement speed of the PWC or the mobile terminal based on a time change of the positional information received from the PWC or the mobile terminal.

The condition for selecting the PWC or the mobile terminal as the transmission target of the warning request or a condition for excluding the PWC or the mobile terminal from the transmission target of the warning request may be able to be set in advance by the user. For example, the transmission target of the warning request may be able to be set in advance by the user. For example, when the watercrafts travel as a group, the watercraft in the group may be able to be selected as the transmission target of the warning request by the setting of the user or may be able to be excluded from the transmission target of the warning request by the setting of the user.

For example, the processing circuitry may select the PWC or the mobile terminal which has a warning request receiving function, as the transmission target to which the warning request should be transmitted. For example, the warning request may be transmitted only to the mobile terminal on which an application program that is at least a part of the driving support program has been installed, and the warning request does not have to be transmitted to the mobile terminal on which the application program has not been installed.

The processing circuitry of the moving machine or the processing circuitry of the mobile terminal that moves together with the moving machine may be configured to be able to be preset so as not to transmit the warning request to the moving machines or mobile terminals of the other users by the operation of the user who utilizes the moving machine.

The above embodiment describes an example in which the warning information is displayed as the image information on the display and an example in which the warning information is output as the sound information. However, the warning information that is any one of the image information and the sound information may be output. Moreover, the warning information may be output as information other than the image information and the sound information. For example, the warning information may be vibration information or optical information. For example, when it is determined that the PWC is within the warning region, the mobile terminal may vibrate, or part of the PWC may vibrate. For example, when it is determined that the PWC is within the warning region, an optical element, such as an LEC, included in the mobile terminal or the PWC may blink or light.

The informer may be an informer mounted on the moving machine for purposes other than the output of the warning information or may be an informer mounted on the moving machine as a special device that outputs the warning information. For example, the display 24 described in the above embodiment serves as the instrument panel, but the display does not have to serve as the instrument panel. For example, the horn 25 described in the above embodiment is a device that generates the horn sound toward the other drivers. However, the horn 25 may be a special deice that outputs the warning information.

The warning region displayed on the display may change depending on the situation. The warning region displayed on the display may be reduced in size with time. Or, the warning region displayed on the display may be increased in size with time.

In the above embodiment, the warning region is displayed based on the warning request from another PWC. However, the warning region may be displayed based on information other than the warning request from another PWC. For example, the memory of the server may prestore information regarding a warning region (hereinafter referred to as a second warning region) that is different in type from a warning region (hereinafter referred to as a first warning region) set based on the warning point. Examples of the second warning region includes: a region where the watercraft tends to run aground; a region into which the watercraft is prohibited from entering; and a region where the speed of the watercraft is limited. In this case, the second warning region may be displayed on the display of the PWC or the display of the mobile terminal which has received the information regarding the second warning region from the server. It is preferable that when both of the first warning region and the second warning region are displayed on the display, the first warning region and the second warning region be displayed in different mode such that the first warning region and the second warning region are distinguishable from each other. For example, the first warning region and the second warning region may be displayed in different colors.

The processing circuitry of the driving support system may be configured to be able to switch whether to validate or invalidate the warning region in accordance with the operation of the user. A validated state of the warning region is a state where whether or not the watercraft is within the warning region is determined, and an invalidated state of the warning region is a state where whether or not the watercraft is within the warning region is not determined. Since the state of the warning region can be switched to the invalidated state by the operation of the user, the warning can be prevented from being output undesirably.

As the method of invalidating the warning region in accordance with the operation of the user, the above embodiment describes a method of transmitting, after the transmission of the warning request, the warning termination instruction to the warned PWC 2b or the warned terminal 4b in accordance with the operation of the user of the warning PWC 2a or the warning terminal 4a. However, the method of invalidating the warning region in accordance with the operation of the user is not limited to this.

For example, previous setting of invalidating the warning region in accordance with the operation of the user may be made. In this case, for example, even when it is determined in Step S3 of FIG. 4 that the user has fallen into water, the falling information does not have to be transmitted from the PWC 2a, or the warning request does not have to be transmitted to the server 3 from the terminal 4a which has received the falling information.

Whether or not the watercraft is within the warning region may be determined by using detection information of the position detection sensor mounted on the watercraft or detection information of the position detection sensor of the mobile terminal located at the watercraft.

The warning point does not have to be the positional information indicating the falling position and may be the positional information indicating the position of the user who has fallen into water. For example, when the user who has fallen into water carries the mobile terminal 4, the position detected by the position detection sensor 49 may be transmitted as the position of the user who has fallen into water, from the mobile terminal 4 to the warned watercraft or the warned terminal through the server at predetermined time intervals. The warning point may move in accordance with the movement of the user who has fallen into water and moves on water.

The falling of the user into water from the PWC is not limited to the falling of the occupant, such as the driver, who is on the PWC 2, and may be the falling of a person who is towed when the PWC is utilized for towed water sports or towed water activities. For example, there is a possibility that the watercraft is stopped on water, and the user dives into water from the watercraft by his/her own will. Such diving of the user into water from the watercraft by his/her own will may also be regarded as the falling of the user into water.

The warning point may be simply the position coordinates that correspond to the center of the warning region. To be specific, the warning point does not have to be the falling position or the position of the user who has fallen into water. In this case, the warning request does not have to include the falling information regarding the falling of the user into water from the watercraft. For example, the warning point may be the position of the watercraft which has been determined as having capsized. For example, the warning point may be the position of a peripheral object located around the watercraft. For example, the warning point may be the position of the warning watercraft itself.

Examples of the peripheral object include: moving objects on and in water; and fixed objects that are artificial objects, such as buildings, and non-artificial natural objects, such as rocks. Examples of the peripheral object that is the moving object may include the above-described swimmers and the other PWCs. Examples of the peripheral object that is the fixed object may include the above-described obstacles on water and in water.

When the warning point is the position of the peripheral object located around the watercraft, the warning condition may change depending on the type of the peripheral object. The warning condition may be made different between when the peripheral object is another PWC and when the peripheral object is a human.

When the peripheral object is the moving object, the warning condition may be set so as to be satisfied more easily than when the peripheral object is the fixed object. The warning region set with respect to the peripheral object (warning point) that is the moving object may be set to become larger than the warning region set with respect to the peripheral object (warning point) that is the fixed object. The warning region set with respect to a human may be set to become larger than the warning region set with respect to the peripheral object other than a human.

The warning request received by the warned PWC or the warned terminal may include the other information, such as the warning point, the warning cause, the information regarding the warning PWC, and the information of the driver of the warning PWC, and these pieces of information may be displayed on the display of the warned PWC or the display of the warned terminal. This can easily urge the warned users to take appropriate actions. For example, the driver of the warned PWC can easily determine whether to approach the warning point or move away from the warning point. For example, by recognizing the information of the driver of the warning PWC and the information of the warning PWC, the user of the warned PWC can easily search for the warning PWC and the user who has fallen into water from the warning PWC.

For example, the warning point may be the position of the watercraft or the user when the watercraft and the user are away from each other. Specifically, the warning point may be the position of a swimmer who is swimming around the watercraft. The warning point may be the position of the watercraft from which the driver is away. The warning point may be information of the position of the watercraft which has stopped driving on water. The warning point may be information of the position of the watercraft which has stopped the driving of the prime mover on water for the purpose of fishing or the like. Even when the methods and configurations of the present disclosure are applied to the land moving machine, the warning point may be the position of the moving machine which has stopped the traveling driving source.

As above, for example, when the user whose purpose is swimming or fishing does not want the other users to approach, the user may transmit the warning request to the other users by his/her own will. Specifically, the warning request may be transmitted to the user of a warned moving machine, such as the warned watercraft, in accordance with the operation of the user of a warning moving machine, such as the warning watercraft. For example, the warning request may be transmitted from the circuitry of the warning watercraft to the circuitry of the warned watercraft or the circuitry of the warned mobile terminal in accordance with the operation of the user with respect to the user interface of the warning watercraft. Or, the warning request may be transmitted from the circuitry of the warning mobile terminal to the circuitry of the warned watercraft or the circuitry of the warned mobile terminal in accordance with the operation of the user with respect to the user interface of the warning mobile terminal. As above, the warning request may be able to be transmitted by the operation of the user of the watercraft.

As the warning condition for transmitting the position of the warning point from the warning PWC 2a, the processing circuitry may set a condition corresponding to environmental information indicating an environment around the warning PWC 2a. For example, the environmental information may be weather, an air temperature, a water temperature, a period of time, a water flow, a wind direction, a wind speed, or any combination thereof. The environmental information may be information detected by the sensor mounted on the PWC or the mobile terminal or information received through the communication interface.

A log of the moving machine which has gone outside the warning region R from the inside of the warning region R may be recorded. For example, as in Modified Example 2 of the warning output processing, when the server 3 determines whether or not the warned PWC 2b is within the warning region R, the CPU 31 of the server 3 may record a time at which each PWC 2 has entered into the warning region R, a time at which each PWC 2 has left the warning region R, and the like from the position of each PWC 2 and the warning region R.

Or, for example, as in Modified Example 2 of the warning output processing, when the server 3 determines whether or not the warned PWC 2b is within the warning region R, the CPU 31 of the server 3 may store information indicating the time at which each PWC 2 has entered into the warning region R, the time at which each PWC 2 has left the warning region R, and the like in the memory from the position of each PWC 2 and the warning region R. Or, when the warned PWC 2b or the warned terminal 4b determines whether or not the warned PWC 2b is within the warning region R, the time at which the warned PWC 2b has entered into the warning region R and the time at which the warned PWC 2b has left the warning region R may be transmitted from the warned PWC 2b or the warned terminal 4b to the server 3 and stored in the memory.

The log stored in the server 3 may be accessible through the network N from a management terminal operated by, for example, a manager of the PWC 2. When the PWC 2 has left the warning region R, notice indicating that the PWC 2 has left the warning region R may be automatically transmitted from the server 3 to the management terminal.

When it is determined that the watercraft has entered into the warning region, the processing circuitry of the watercraft or the processing circuitry of the mobile terminal that moves together with the watercraft may execute a special event. The special event may be, for example, data record processing for the warning region, data communication processing for the warning region, control for the warning region with respect to various devices of the watercraft, or the like.

For example, when the processing circuitry of the watercraft or the processing circuitry of the mobile terminal determines that the watercraft has entered into the warning region, the processing circuitry of the watercraft or the processing circuitry of the mobile terminal may store in the memory, movement route information indicating a movement route of the watercraft within the warning region. The movement route information may be time-series data of the position of the watercraft which is detected by the position detection sensor or time-series data of the position of the mobile terminal which is detected by the position detection sensor.

Moreover, for example, when the processing circuitry of the watercraft or the processing circuitry of the mobile terminal determines that the watercraft has entered into the warning region, the processing circuitry of the watercraft or the processing circuitry of the mobile terminal may transmit notice indicating that the watercraft has entered into the warning region, to the server or the other watercrafts.

Moreover, for example, when the processing circuitry of the watercraft determines that the watercraft has entered into the warning region, the processing circuitry of the watercraft may execute control of suppressing the traveling speed or propulsive force of the watercraft.

The driving support system that supports the driving of the moving machine may include: the antenna that wirelessly receives the warning request including the positional information of the warning point; the position detection sensor that detects the position of the moving machine; the informer; and the processing circuitry configured to determine whether or not the position of the moving machine which has been detected by the position detection sensor is within the warning region including the warning point indicated by the warning request received by the antenna, and when the processing circuitry determines that the position of the moving machine is within the warning region, output the warning information by using the informer. When the processing circuitry of the driving support system acquires separating information indicating that the user of the moving machine has separated from the moving machine during the traveling of the moving machine, the processing circuitry of the driving support system may wirelessly transmit to the other moving machines the warning request including as the positional information of the warning point the position of the moving machine or the position of the user who has separated from the moving machine. Moreover, the antenna, the position detection sensor, and the processing circuitry may be included in the mobile terminal carried by the user on the moving machine.

In the above embodiment, whether or not the warned PWC 2b is within the warning region R is determined. However, the processing circuitry of the driving support system does not have to determine whether or not the warned PWC 2b is within the warning region R. For example, the processing circuitry of the driving support system may be configured to: receive the falling information indicating that the user has fallen into water from the warning PWC different from the warned PWC that is the PWC, the warning PWC being another PWC, the falling information including the information regarding the falling position or the position of the user who has fallen into water; and display the warning region surrounding the position indicated by the falling information on the display located at the warned PWC. By displaying the warning region on the display, the driver of the warned PWC can be warned such that the warned PWC does not approach the user who has fallen into water, at high speed. In this case, for example, the driving support system may include: the antenna which is located at the warned PWC and wirelessly receives the falling information indicating that the user has fallen into water from the warning PWC different from the warned PWC that is the PWC, the warning PWC being another PWC, the falling information including the information regarding the falling position or the position of the user who has fallen into water; the display located at the warned PWC; and the processing circuitry configured to display on the display the warning region surrounding the position indicated by the falling information.

The functionality of the elements disclosed herein may be implemented using circuitry or processing circuitry which includes general purpose processors, special purpose processors, integrated circuits, ASICs (“Application Specific Integrated Circuits”), conventional circuitry and/or combinations thereof which are configured or programmed to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein or otherwise known which is programmed or configured to carry out the recited functionality. When the hardware is a processor which may be considered a type of circuitry, the circuitry, means, or units are a combination of hardware and software, the software being used to configure the hardware and/or processor.

Moreover, various programs disclosed in the present specification are stored in a storage. The storage is a device which is incorporated in or externally attached to a computer and is readable and writable or is readable. For example, the storage may be a hard disk, a flash memory, an optical disk, or the like. The program stored in the storage may be executed by a computer to which the storage is directly connected or may be downloaded to and executed by a computer connected to the storage through a network (for example, the Internet).

### Disclosed Aspects

The following aspects disclose preferred embodiments.

### First Aspect

A driving support method of supporting driving of a watercraft,
the driving support method including:
by processing circuitry,
receiving a warning request including positional information of a warning point;
determining whether or not the watercraft is within a warning region including the warning point; and
when the processing circuitry determines that the watercraft is within the warning region, outputting warning information.

According to the above aspect, by the output of the warning information, the user is made to recognize that the user is driving within the warning region. Thus, the driving of the user can be supported.

### Second Aspect

The driving support method according to the first aspect, wherein the warning region includes an inside warning region including the warning point and an annular outside warning region surrounding the inside warning region,
the driving support method including:
by the processing circuitry,
when the processing circuitry determines that the watercraft is within the inside warning region, outputting inside warning information as the warning information; and
when the processing circuitry determines that the watercraft is within the outside warning region, outputting outside warning information as the warning information, the outside warning information being different from the inside warning information.

According to the above aspect, depending on whether the inside warning information has been output or the outside warning information has been output, the user can easily recognize how close to the warning point the watercraft of the user is located. Thus, the convenience of the user improves.

### Third Aspect

The driving support method according to the second aspect, wherein a degree of warning of an output form of the inside warning information is higher than a degree of warning of an output form of the outside warning information.

According to the above aspect, when the watercraft is within the inside warning region, the user can be warned more strongly. Thus, for example, the watercraft is easily prevented from approaching the warning point.

### Fourth Aspect

The driving support method according to any one of the first to third aspects, wherein outputting the warning information includes outputting the warning information by using an informer mounted on the watercraft.

According to the above aspect, by outputting the warning information by using the informer of the watercraft, the user of the watercraft can easily recognize the warning.

### Fifth Aspect

The driving support method according to any one of the first to fourth aspects, wherein outputting the warning information includes outputting the warning information by using an informer mounted on the mobile terminal.

According to the above aspect, since the warning information is output by using the informer mounted on the mobile terminal, the user can be made to recognize the warning without using the informer of the watercraft. Or, when the warning information is output by using both of the informer mounted on the mobile terminal and the informer of the watercraft, the user can be made to easily recognize the warning.

### Sixth Aspect

The driving support method according to any one of the first to fifth aspects, wherein the warning request includes falling information regarding falling of a user into water from a warning watercraft different from a warned watercraft that is the watercraft, the warning watercraft being another watercraft.

According to the above aspect, the user of the warned watercraft can be urged such that the warned watercraft does not approach the user who has fallen into water from the warning watercraft, or the warned watercraft travels slowly to rescue the user who has fallen into water from the warning watercraft.

### Seventh Aspect

The driving support method according to the sixth aspect, wherein the warning point is a position at which the user has fallen into water from the warning watercraft or a position of the user who has fallen into water from the warning watercraft.

### Eighth Aspect

The driving support method according to the sixth or seventh aspect, further including
by the processing circuitry,
determining whether or not the user has fallen into water from the warning watercraft, in accordance with a communication state between a PWC communicator located at the warning watercraft and a user communicator worn by the user who has fallen into water.

According to the above aspect, whether or not the user has fallen into water from the watercraft can be determined by a simple method.

### Ninth Aspect

The driving support method according to any one of the sixth to eighth aspects, wherein the falling information includes user type information indicating a type of the user who has fallen into water,
the driving support method including
outputting the user type information by the processing circuitry.

According to the above aspect, the driver of the watercraft can recognize the type of the user who has fallen into water, from the user type information displayed on the display.

### Tenth Aspect

The driving support method according to any one of the first to ninth aspects, wherein:
the warning region is a region including a warning watercraft different from a warned watercraft that is the watercraft, the warning watercraft being another watercraft; and
the processing circuitry includes
   warned processing circuitry located at the warned watercraft and
   warning processing circuitry located at the warning watercraft,
the driving support method further including:
by the warning processing circuitry, transmitting the warning request to the warned processing circuitry in accordance with operation of the user of the warning watercraft.

According to the above aspect, the output of the warning region can be requested by the operation of the user of the watercraft.

### Eleventh Aspect

The driving support method according to any one of the first to tenth aspects, further including:
by the processing circuitry,
determining whether or not a preset warning termination condition has been satisfied; and
when the processing circuitry determines that the warning termination condition has been satisfied, terminating the determination regarding whether or not the watercraft is within the warning region.

According to the above aspect, the warning can be prevented from continuing undesirably.

### Twelfth Aspect

The driving support method according to any one of the first to eleventh aspects, wherein outputting the warning information includes displaying a positional relation between a position of the watercraft and the warning region on a display by the processing circuitry.

According to the above aspect, the user of the watercraft can easily determine that the watercraft has entered into the warning region.

### Thirteenth Aspect

The driving support method according to any one of the first to twelfth aspects, wherein outputting the warning information includes displaying a positional relation between a position of the warning point and the warning region on a display by the processing circuitry.

According to the above aspect, the user of the watercraft can easily recognize the position of the warning point.

### Fourteenth Aspect

The driving support method according to any one of the first to thirteenth aspects, further including switching the warning region between a validated state and an invalidated state by the processing circuitry in accordance with operation of the user.

According to the above aspect, since the state of the warning region can be switched to the invalidated state by the operation of the user, the warning can be prevented from being output undesirably.

### Fifteenth Aspect

The driving support method according to any one of the first to fourteenth aspects, further including:
by the processing circuitry,
when the processing circuitry determines that the watercraft is not within the warning region, setting a control mode by which a traveling driving source of the watercraft is controlled, to a normal traveling mode; and
when the processing circuitry determines that the watercraft is within the warning region, setting the control mode to a speed limiting mode that limits a maximum speed such that the maximum speed becomes lower than a maximum speed when the control mode is the normal traveling mode.

According to the above aspect, regardless of whether or not the user of the watercraft recognizes that the watercraft is within the warning region, the watercraft can be prevented from traveling at high speed in the vicinity of the warning point.

### Sixteenth Aspect

The driving support method according to any one of the first to fifteenth aspects, further including:
by the processing circuitry,
receiving falling information indicating that the user has fallen into water from a warning watercraft different from a warned watercraft that is the watercraft, the warning watercraft being another watercraft, the falling information including information regarding a falling position or a position of the user who has fallen into water; and
regardless of a result of the determination regarding whether or not the warned watercraft is within the warning region, displaying the warning region surrounding the position indicated by the falling information, on a display located at the warned watercraft.

According to the above aspect, regardless of whether or not the warning information is output, the warning region is displayed on the display. Therefore, the user outside the warning region can be made to recognize the falling information.

### Seventeenth Aspect

A driving support system that supports driving of a moving machine,
the driving support system including:
an antenna that wirelessly receives a warning request including positional information of a warning point;
a position detection sensor that detects a position of the moving machine;
an informer; and
processing circuitry configured to
   determine whether or not the position of the moving machine which has been detected by the position detection sensor is within a warning region including the warning point indicated by the warning request received by the antenna, and
   when the processing circuitry determines that the position of the moving machine is within the warning region, output warning information by using the informer.

### Eighteenth Aspect

The driving support system according to the seventeenth aspect, wherein when the processing circuitry acquires separating information indicating that a user of the moving machine has separated from the moving machine during traveling of the moving machine, the processing circuitry wirelessly transmits to another moving machine the warning request including as the positional information of the warning point the position of the moving machine or a position of the user who has separated from the moving machine.

### Nineteenth Aspect

The driving support system according to the seventeenth or eighteenth aspect, wherein the antenna, the position detection sensor, and the processing circuitry are included in a mobile terminal carried by the user on the moving machine.

### Twentieth Aspect

A driving support system that supports driving of a watercraft,
the driving support system including:
an antenna which is located at a warned watercraft and wirelessly receives falling information indicating that a user has fallen into water from a warning watercraft different from the warned watercraft that is the watercraft, the warning watercraft being another watercraft, the falling information including information regarding a falling position or a position of the user who has fallen into water;
a display located at the warned watercraft; and
processing circuitry configured to display on the display a warning region surrounding the position indicated by the falling information.

The foregoing has described the embodiments as examples of the technology disclosed in the present application. However, the technology in the present disclosure is not limited to these and is applicable to embodiments in which modifications, replacements, additions, omissions, and the like have been suitably made. Moreover, a new embodiment may be prepared by combining the components described in the above embodiments. For example, some of components or methods in one embodiment may be applied to another embodiment. Some components in an embodiment may be separated from the other components in the embodiment and arbitrarily extracted. Furthermore, the components shown in the attached drawings and the detailed explanations include not only components essential to solve the problems but also components for exemplifying the above technology and not essential to solve the problems.

What is claimed is:

1. A driving support method of supporting driving of a watercraft,
the driving support method comprising:
by processing circuitry,
receiving a warning request including positional information of a warning point;
determining whether or not the watercraft is within a warning region including the warning point; and
when the processing circuitry determines that the watercraft is within the warning region, outputting warning information.

2. The driving support method according to claim 1, wherein the warning region includes an inside warning region including the warning point and an annular outside warning region surrounding the inside warning region,
the driving support method comprising:
by the processing circuitry,
when the processing circuitry determines that the watercraft is within the inside warning region, outputting inside warning information as the warning information; and
when the processing circuitry determines that the watercraft is within the outside warning region, outputting outside warning information as the warning information, the outside warning information being different from the inside warning information.

3. The driving support method according to claim 2, wherein a degree of warning of an output form of the inside warning information is higher than a degree of warning of an output form of the outside warning information.

4. The driving support method according to claim 1, wherein outputting the warning information includes outputting the warning information by using an informer mounted on the watercraft.

5. The driving support method according to claim 1, wherein outputting the warning information includes outputting the warning information by using an informer mounted on the mobile terminal.

6. The driving support method according to claim 1, wherein the warning request includes falling information regarding falling of a user into water from a warning watercraft different from a warned watercraft that is the watercraft, the warning watercraft being another watercraft.

7. The driving support method according to claim 6, wherein the warning point is a position at which the user has fallen into water from the warning watercraft or a position of the user who has fallen into water from the warning watercraft.

8. The driving support method according to claim 6, further comprising
by the processing circuitry,
determining whether or not the user has fallen into water from the warning watercraft, in accordance with a communication state between a PWC communicator located at the warning watercraft and a user communicator worn by the user who has fallen into water.

9. The driving support method according to claim 6, wherein the falling information includes user type information indicating a type of the user who has fallen into water,
the driving support method comprising
outputting the user type information by the processing circuitry.

10. The driving support method according to claim 1, wherein:
the warning region is a region including a warning watercraft different from a warned watercraft that is the watercraft, the warning watercraft being another watercraft; and
the processing circuitry includes
warned processing circuitry located at the warned watercraft and
warning processing circuitry located at the warning watercraft,
the driving support method further comprising:
by the warning processing circuitry, transmitting the warning request to the warned processing circuitry in accordance with operation of the user of the warning watercraft.

11. The driving support method according to claim 1, further comprising:
by the processing circuitry,
determining whether or not a preset warning termination condition has been satisfied; and
when the processing circuitry determines that the warning termination condition has been satisfied, terminating the determination regarding whether or not the watercraft is within the warning region.

12. The driving support method according to claim 1, wherein outputting the warning information includes displaying a positional relation between a position of the watercraft and the warning region on a display by the processing circuitry.

13. The driving support method according to claim 1, wherein outputting the warning information includes displaying a positional relation between a position of the warning point and the warning region on a display by the processing circuitry.

14. The driving support method according to claim 1, further comprising switching the warning region between a validated state and an invalidated state by the processing circuitry in accordance with operation of the user.

15. The driving support method according to claim 1, further comprising:
by the processing circuitry,
when the processing circuitry determines that the watercraft is not within the warning region, setting a control mode by which a traveling driving source of the watercraft is controlled, to a normal traveling mode; and
when the processing circuitry determines that the watercraft is within the warning region, setting the control mode to a speed limiting mode that limits a maximum speed such that the maximum speed becomes lower than a maximum speed when the control mode is the normal traveling mode.

16. The driving support method according to claim 1, further comprising:
by the processing circuitry,
receiving falling information indicating that the user has fallen into water from a warning watercraft different from a warned watercraft that is the watercraft, the warning watercraft being another watercraft, the falling information including information regarding a falling position or a position of the user who has fallen into water; and
regardless of a result of the determination regarding whether or not the warned watercraft is within the warning region, displaying the warning region surrounding the position indicated by the falling information, on a display located at the warned watercraft.

17. A driving support system that supports driving of a moving machine,
the driving support system comprising:
an antenna that wirelessly receives a warning request including positional information of a warning point;
a position detection sensor that detects a position of the moving machine;
an informer; and
processing circuitry configured to
determine whether or not the position of the moving machine which has been detected by the position detection sensor is within a warning region including the warning point indicated by the warning request received by the antenna, and
when the processing circuitry determines that the position of the moving machine is within the warning region, output warning information by using the informer.

18. The driving support system according to claim 17, wherein when the processing circuitry acquires separating information indicating that a user of the moving machine has separated from the moving machine during traveling of the moving machine, the processing circuitry wirelessly transmits to another moving machine the warning request including as the positional information of the warning point the position of the moving machine or a position of the user who has separated from the moving machine.

19. The driving support system according to claim 17, wherein the antenna, the position detection sensor, and the processing circuitry are included in a mobile terminal carried by the user on the moving machine.

20. A driving support system that supports driving of a watercraft,
the driving support system comprising:
an antenna which is located at a warned watercraft and wirelessly receives falling information indicating that a user has fallen into water from a warning watercraft different from the warned watercraft that is the watercraft, the warning watercraft being another watercraft, the falling information including information regarding a falling position or a position of the user who has fallen into water;
a display located at the warned watercraft; and
processing circuitry configured to display on the display a warning region surrounding the position indicated by the falling information.
